(19) United States
(12) Patent Application Publication
(10) Pub. No.: US 2026/0262632 A1
(43) Pub. Date: Sep. 10, 2026

(54) COMPOSITIONS AND METHODS FOR TANK-MIX SPRAY APPLICATION OF 1-MCP

(71) Applicant: AGROFRESH INC., Philadelphia, PA (US)

(72) Inventors: Lei LIU, Lansdale, PA (US); Fiona WEHMEYER, Roslyn, PA (US)

(21) Appl. No.: 19/165,302

(22) PCT Filed: Mar. 15, 2024
(86) PCT No.: PCT/US2024/020101

§ 371 Date: Sep. 15, 2025

Related U.S. Application Data
(60) Provisional application No. 63/452,240, filed on Mar. 15, 2023.

(51) Int. Cl. A01N 25/02; A01N 27/00

(52) U.S. Cl. CPC A01N 25/02; A01N 27/00

(57) ABSTRACT

The present disclosure provides both solid compositions and aqueous compositions, as well as methods thereof, that address the problems known in the art by including a gas-confining agent. The compositions and methods of the present disclosure allow for a larger volume of a solvent such as water to be present in an aqueous composition so that a significant portion of 1-MCP can be retained in the aqueous composition prior to application to plants or plant parts. Furthermore, the compositions and methods provide improved safety of aqueous compositions in that a lower concentration of gaseous 1-MCP is present in the headspace of a tank or vessel, thereby minimizing flammability.

### CROSS-REFERENCE TO RELATED APPLICATIONS

This application claims the benefit under 35 USC § 119(e) of U.S. Provisional Application Ser. No. 63/452,240, filed on Mar. 15, 2023, the entire disclosure of which is incorporated herein by reference.

### BACKGROUND AND SUMMARY

Cyclopropene compounds such as 1-Methylcyclopropene (1-MCP) are useful for treating plants or plant parts. However, gaseous 1-MCP is difficult to handle and store and is also flammable above a concentration of 13,300 parts per million (ppm). As a result, in current agriculture applications, 1-MCP can be stabilized in a complex, for instance with molecular encapsulating agents, complexing agents, inclusion agents, and the like. As an example, 1-MCP can be stabilized into a clathrate such as α-cyclodextrin (alpha-cyclodextrin or α-CD) to ease handling during storage and transportation.

By contacting complexed cyclopropene with a solvent (for example tap water), cyclopropene molecules can be released from the complex into air space. As a result, liquid (especially aqueous) formulations of complexed cyclopropene compounds are typically unstable for storage purpose. Upon contact with water or even moisture, 1-MCP gas will be quickly released at a rate which is not compatible with tank use as most of the gas will be lost in the tank headspace before the product has a chance to be sprayed in the field.

Accordingly, there remains a need to develop stable liquid formulations for volatile compounds such as 1-MCP, especially for storage of the compounds for field applications.

The present disclosure provides both solid compositions and aqueous compositions, as well as methods thereof, that address the problems known in the art by including a gas-confining agent. The compositions and methods of the present disclosure allow for a larger volume of a solvent such as water to be present in an aqueous composition so that a significant portion of 1-MCP can be retained in the aqueous composition prior to application to plants or plant parts. Furthermore, the compositions and methods provide improved safety of aqueous compositions in that a lower concentration of gaseous 1-MCP is present in the headspace of a tank or vessel, thereby minimizing flammability.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTIONS OF THE DRAWINGS

The detailed description particularly refers to the accompanying figures in which:

FIG. 1 shows the concentration of 1-MCP present in the headspace of a container (ppm) with various gas-containing agent (“adjuvant”) percentages and administration levels.

FIG. 2 shows the concentration of 1-MCP remaining in solution (%) with various gas-containing agent percentages (“adjuvant”) and administration levels.

FIG. 3 shows the concentration of 1-MCP present in the headspace of a container (ppm) with various gas-containing agent (“adjuvant”) percentages and administration levels.

FIG. 4 shows the categories of coverage color analyzed for fruits.

FIG. 5 shows the color distribution of fruits at Harvest H0.

FIG. 5 shows the color distribution of fruits at 7 days after commercial Harvest (H+7).

FIG. 7 shows the color distribution of fruits at 14 days after commercial Harvest (H+14).

### DETAILED DESCRIPTION

In an illustrative aspect, an aqueous composition is provided. The aqueous composition comprises i) 1-MCP, ii) a gas-confining agent, and iii) water. Amongst the various embodiments, the aqueous composition can be a pre-mix composition in which the 1-MCP and the gas-confining agent are combined with the water at the point of use (e.g., a backpack application, a drone application, or the like). Alternatively, amongst the various embodiments, the aqueous composition can be a tank-mix composition in which the 1-MCP is combined with the gas-confining agent and the water at the point of use (e.g., a field-based).

In an embodiment, the 1-MCP is comprised in a complex. In an embodiment, the complex is an inclusion complex. In an embodiment, the inclusion complex comprises cyclodextrin. In an embodiment, the inclusion complex comprises alpha-cyclodextrin. In an embodiment, the inclusion complex consists essentially of alpha-cyclodextrin. In an embodiment, the inclusion complex consists of alpha-cyclodextrin.

In an embodiment, the gas-confining agent is derived from the inclusion complex. In an embodiment, the complex is suspended as solid particles in the aqueous composition. In an embodiment, the solid particle size is of an average between about 0.5 μm to about 30 μm.

In an embodiment, the complex is air milled. In an embodiment, the complex is solubilized in the aqueous composition.

In an embodiment, the complex is present at a concentration from about 0.1% to about 50% by weight of the aqueous composition. In an embodiment, the complex is present at a concentration from about 0.5% to about 30% by weight of the aqueous composition. In an embodiment, the complex is present at a concentration from about 0.5% to about 20% by weight of the aqueous composition. In an embodiment, the complex is present at a concentration from about 0.5% to about 10% by weight of the aqueous composition.

In an embodiment, the 1-MCP is comprised in a solution. In an embodiment, the 1-MCP is present in the solution at about 0.1% to about 1.0%. In an embodiment, the 1-MCP is present in the solution at about 1% to about 2%. In an embodiment, the 1-MCP is present in the solution at about 2% to about 3%. In an embodiment, the 1-MCP is present in the solution at about 3% to about 4%. In an embodiment, the 1-MCP is present in the solution at about 4% to about 5%.

In an embodiment, the 1-MCP is present in the solution at about 1%. In an embodiment, the 1-MCP is present in the solution at about 1.1%. In an embodiment, the 1-MCP is present in the solution at about 1.2%. In an embodiment, the 1-MCP is present in the solution at about 1.3%. In an embodiment, the 1-MCP is present in the solution at about 1.4%. In an embodiment, the 1-MCP is present in the solution at about 1.5%. In an embodiment, the 1-MCP is present in the solution at about 1.6%. In an embodiment, the 1-MCP is present in the solution at about 1.7%. In an embodiment, the 1-MCP is present in the solution at about 1.8%. In an embodiment, the 1-MCP is present in the solution at about 1.9%. In an embodiment, the 1-MCP is present in the solution at about 2%. In an embodiment, the 1-MCP is present in the solution at about 2.1%. In an embodiment, the 1-MCP is present in the solution at about 2.2%. In an embodiment, the 1-MCP is present in the solution at about 2.3%. In an embodiment, the 1-MCP is present in the solution at about 2.4%. In an embodiment, the 1-MCP is present in the solution at about 2.5%. In an embodiment, the 1-MCP is present in the solution at about 2.6%. In an embodiment, the 1-MCP is present in the solution at about 2.7%. In an embodiment, the 1-MCP is present in the solution at about 2.8%. In an embodiment, the 1-MCP is present in the solution at about 2.9%. In an embodiment, the 1-MCP is present in the solution at about 3%. In an embodiment, the 1-MCP is present in the solution at about 3.1%. In an embodiment, the 1-MCP is present in the solution at about 3.2%. In an embodiment, the 1-MCP is present in the solution at about 3.3%. In an embodiment, the 1-MCP is present in the solution at about 3.4%. In an embodiment, the 1-MCP is present in the solution at about 3.5%. In an embodiment, the 1-MCP is present in the solution at about 3.6%. In an embodiment, the 1-MCP is present in the solution at about 3.7%. In an embodiment, the 1-MCP is present in the solution at about 3.8%. In an embodiment, the 1-MCP is present in the solution at about 3.9%. In an embodiment, the 1-MCP is present in the solution at about 4%. In an embodiment, the 1-MCP is present in the solution at about 4.1%. In an embodiment, the 1-MCP is present in the solution at about 4.2%. In an embodiment, the 1-MCP is present in the solution at about 4.3%. In an embodiment, the 1-MCP is present in the solution at about 4.4%. In an embodiment, the 1-MCP is present in the solution at about 4.5%. In an embodiment, the 1-MCP is present in the solution at about 4.6%. In an embodiment, the 1-MCP is present in the solution at about 4.7%. In an embodiment, the 1-MCP is present in the solution at about 4.8%. In an embodiment, the 1-MCP is present in the solution at about 4.9%. In an embodiment, the 1-MCP is present in the solution at about 5%.

In an embodiment, the 1-MCP is comprised in a powder. In an embodiment, the powder is a wettable powder. As used herein, a wettable powder refers to a powder that is capable of being wetted with a liquid, for instance water. In certain aspects, a wettable powder refers to a powder comprising 1-MCP in which addition of a liquid does not release a substantial amount of gaseous 1-MCP from the powder. In an embodiment, the 1-MCP is present in the powder at about 0.1% to about 1.0%. In an embodiment, the 1-MCP is present in the powder at about 1% to about 2%. In an embodiment, the 1-MCP is present in the powder at about 2% to about 3%. In an embodiment, the 1-MCP is present in the powder at about 3% to about 4%. In an embodiment, the 1-MCP is present in the powder at about 4% to about 5%.

In an embodiment, the 1-MCP is present in the powder at about 1%. In an embodiment, the 1-MCP is present in the powder at about 1.1%. In an embodiment, the 1-MCP is present in the powder at about 1.2%. In an embodiment, the 1-MCP is present in the powder at about 1.3%. In an embodiment, the 1-MCP is present in the powder at about 1.4%. In an embodiment, the 1-MCP is present in the powder at about 1.5%. In an embodiment, the 1-MCP is present in the powder at about 1.6%. In an embodiment, the 1-MCP is present in the powder at about 1.7%. In an embodiment, the 1-MCP is present in the powder at about 1.8%. In an embodiment, the 1-MCP is present in the powder at about 1.9%. In an embodiment, the 1-MCP is present in the powder at about 2%. In an embodiment, the 1-MCP is present in the powder at about 2.1%. In an embodiment, the 1-MCP is present in the powder at about 2.2%. In an embodiment, the 1-MCP is present in the powder at about 2.3%. In an embodiment, the 1-MCP is present in the powder at about 2.4%. In an embodiment, the 1-MCP is present in the powder at about 2.5%. In an embodiment, the 1-MCP is present in the powder at about 2.6%. In an embodiment, the 1-MCP is present in the powder at about 2.7%. In an embodiment, the 1-MCP is present in the powder at about 2.8%. In an embodiment, the 1-MCP is present in the powder at about 2.9%. In an embodiment, the 1-MCP is present in the powder at about 3%. In an embodiment, the 1-MCP is present in the powder at about 3.1%. In an embodiment, the 1-MCP is present in the powder at about 3.2%. In an embodiment, the 1-MCP is present in the powder at about 3.3%. In an embodiment, the 1-MCP is present in the powder at about 3.4%. In an embodiment, the 1-MCP is present in the powder at about 3.5%. In an embodiment, the 1-MCP is present in the powder at about 3.6%. In an embodiment, the 1-MCP is present in the powder at about 3.7%. In an embodiment, the 1-MCP is present in the powder at about 3.8%. In an embodiment, the 1-MCP is present in the powder at about 3.9%. In an embodiment, the 1-MCP is present in the powder at about 4%. In an embodiment, the 1-MCP is present in the powder at about 4.1%. In an embodiment, the 1-MCP is present in the powder at about 4.2%. In an embodiment, the 1-MCP is present in the powder at about 4.3%. In an embodiment, the 1-MCP is present in the powder at about 4.4%. In an embodiment, the 1-MCP is present in the powder at about 4.5%. In an embodiment, the 1-MCP is present in the powder at about 4.6%. In an embodiment, the 1-MCP is present in the powder at about 4.7%. In an embodiment, the 1-MCP is present in the powder at about 4.8%. In an embodiment, the 1-MCP is present in the powder at about 4.9%. In an embodiment, the 1-MCP is present in the powder at about 5%.

As described herein, a gas-confining agent refers to a component that is capable of preventing or reducing the release of gaseous material (e.g., gaseous 1-MCP) into the headspace of a vessel or container. Alternatively, or in addition, a gas-confining agent refers to a component that is capable of preventing or reducing the release of gaseous material (e.g., gaseous 1-MCP) into the atmosphere, thereby preventing/reducing loss of the gaseous material and/or the loss of retention of the gaseous material in the aqueous composition before its eventual use or application to achieve agricultural benefits. In an embodiment, the gas-confining agent is selected from the group consisting of alpha cyclodextrin, activated charcoal, activated carbon, porous silica, molecular sieve, and any combination thereof. In an embodiment, the gas-confining agent comprises alpha cyclodextrin. In an embodiment, the gas-confining agent comprises activated charcoal. In an embodiment, the gas-confining agent comprises activated carbon. In an embodiment, the gas-confining agent comprises porous silica. In an embodiment, the gas-confining agent comprises a molecular sieve.

In an embodiment, the gas-confining agent is from about 0.1% to about 50% by weight of the water in the aqueous composition. In an embodiment, the gas-confining agent is from about 1% to about 30% by weight of the water in the aqueous composition. In an embodiment, the gas-confining agent is from about 2% to about 20% by weight of the water in the aqueous composition. In an embodiment, the gas-confining agent is from about 2.5% to about 15% by weight of the water in the aqueous composition. In an embodiment, the gas-sequestering agent is from about 1% to about 10% by weight of the water in the aqueous composition. In an embodiment, the gas-sequestering agent is from about 3% to about 10% by weight of the water in the aqueous composition. In an embodiment, the gas-sequestering agent is about 1% by weight of the water in the aqueous composition. In an embodiment, the gas-sequestering agent is about 2% by weight of the water in the aqueous composition. In an embodiment, the gas-sequestering agent is about 3% by weight of the water in the aqueous composition. In an embodiment, the gas-sequestering agent is about 4% by weight of the water in the aqueous composition. In an embodiment, the gas-sequestering agent is about 5% by weight of the water in the aqueous composition. In an embodiment, the gas-sequestering agent is about 6% by weight of the water in the aqueous composition. In an embodiment, the gas-sequestering agent is about 7% by weight of the water in the aqueous composition. In an embodiment, the gas-sequestering agent is about 8% by weight of the water in the aqueous composition. In an embodiment, the gas-sequestering agent is about 9% by weight of the water in the aqueous composition. In an embodiment, the gas-sequestering agent is about 10% by weight of the water in the aqueous composition. In an embodiment, the gas-sequestering agent is about 11% by weight of the water in the aqueous composition. In an embodiment, the gas-sequestering agent is about 12% by weight of the water in the aqueous composition. In an embodiment, the gas-sequestering agent is about 13% by weight of the water in the aqueous composition. In an embodiment, the gas-sequestering agent is about 14% by weight of the water in the aqueous composition. In an embodiment, the gas-sequestering agent is about 15% by weight of the water in the aqueous composition.

In an embodiment, the total amount of 1-MCP in the aqueous composition is retained at least 10% by weight of the initial amount of 1-MCP over a period of 24 hours. In an embodiment, the total amount of 1-MCP in the aqueous composition is retained at least 25% by weight of the initial amount of 1-MCP over a period of 24 hours. In an embodiment, the total amount of 1-MCP in the aqueous composition is retained at least 50% by weight of the initial amount of 1-MCP over a period of 24 hours. In an embodiment, the total amount of 1-MCP in the aqueous composition is retained at least 75% by weight of the initial amount of 1-MCP over a period of 24 hours.

In an embodiment, the aqueous composition further comprises a water conditioning agent, a metal chelating agent, a pH controlling agent, a biocide, a preservative, a surfactant, a dispersant, a wetting agent, a spray adjuvant, a polymer, or any combination thereof. In an embodiment, the aqueous composition further comprises a fungicide, an insecticide, a herbicide, a fertilizer, a nutrient, or any combination thereof.

In an illustrative aspect, a solid composition comprising i) 1-MCP and ii) a gas-confining agent.

In an embodiment, the 1-MCP is comprised in a complex. In an embodiment, the complex is an inclusion complex. In an embodiment, the inclusion complex comprises cyclodextrin. In an embodiment, the inclusion complex comprises alpha-cyclodextrin. In an embodiment, the inclusion complex consists essentially of alpha-cyclodextrin. In an embodiment, the inclusion complex consists of alpha-cyclodextrin.

In an embodiment, the gas-confining agent is derived from the inclusion complex. In an embodiment, the complex is present as solid particles in the solid composition. In an embodiment, the solid particle size is of an average between about 0.5 μm to about 30 μm.

In an embodiment, the complex is air milled. In an embodiment, the complex is from about 2% to about 90% by weight of the total composition.

In an embodiment, the 1-MCP is comprised in a powder. In an embodiment, the powder is a wettable powder. In an embodiment, the 1-MCP is present in the powder at about 0.1% to about 1.0%. In an embodiment, the 1-MCP is present in the powder at about 1% to about 2%. In an embodiment, the 1-MCP is present in the powder at about 2% to about 3%. In an embodiment, the 1-MCP is present in the powder at about 3% to about 4%. In an embodiment, the 1-MCP is present in the powder at about 4% to about 5%.

In an embodiment, the 1-MCP is present in the powder at about 1%. In an embodiment, the 1-MCP is present in the powder at about 1.1%. In an embodiment, the 1-MCP is present in the powder at about 1.2%. In an embodiment, the 1-MCP is present in the powder at about 1.3%. In an embodiment, the 1-MCP is present in the powder at about 1.4%. In an embodiment, the 1-MCP is present in the powder at about 1.5%. In an embodiment, the 1-MCP is present in the powder at about 1.6%. In an embodiment, the 1-MCP is present in the powder at about 1.7%. In an embodiment, the 1-MCP is present in the powder at about 1.8%. In an embodiment, the 1-MCP is present in the powder at about 1.9%. In an embodiment, the 1-MCP is present in the powder at about 2%. In an embodiment, the 1-MCP is present in the powder at about 2.1%. In an embodiment, the 1-MCP is present in the powder at about 2.2%. In an embodiment, the 1-MCP is present in the powder at about 2.3%. In an embodiment, the 1-MCP is present in the powder at about 2.4%. In an embodiment, the 1-MCP is present in the powder at about 2.5%. In an embodiment, the 1-MCP is present in the powder at about 2.6%. In an embodiment, the 1-MCP is present in the powder at about 2.7%. In an embodiment, the 1-MCP is present in the powder at about 2.8%. In an embodiment, the 1-MCP is present in the powder at about 2.9%. In an embodiment, the 1-MCP is present in the powder at about 3%. In an embodiment, the 1-MCP is present in the powder at about 3.1%. In an embodiment, the 1-MCP is present in the powder at about 3.2%. In an embodiment, the 1-MCP is present in the powder at about 3.3%. In an embodiment, the 1-MCP is present in the powder at about 3.4%. In an embodiment, the 1-MCP is present in the powder at about 3.5%. In an embodiment, the 1-MCP is present in the powder at about 3.6%. In an embodiment, the 1-MCP is present in the powder at about 3.7%. In an embodiment, the 1-MCP is present in the powder at about 3.8%. In an embodiment, the 1-MCP is present in the powder at about 3.9%. In an embodiment, the 1-MCP is present in the powder at about 4%. In an embodiment, the 1-MCP is present in the powder at about 4.1%. In an embodiment, the 1-MCP is present in the powder at about 4.2%. In an embodiment, the 1-MCP is present in the powder at about 4.3%. In an embodiment, the 1-MCP is present in the powder at about 4.4%. In an embodiment, the 1-MCP is present in the powder at about 4.5%. In an embodiment, the 1-MCP is present in the powder at about 4.6%. In an embodiment, the 1-MCP is present in the powder at about 4.7%. In an embodiment, the 1-MCP is present in the powder at about 4.8%. In an embodiment, the 1-MCP is present in the powder at about 4.9%. In an embodiment, the 1-MCP is present in the powder at about 5%.

In an embodiment, the gas-confining agent is selected from the group consisting of alpha cyclodextrin, activated charcoal, activated carbon, porous silica, molecular sieve, and any combination thereof. In an embodiment, the gas-confining agent comprises alpha cyclodextrin. In an embodiment, the gas-confining agent comprises activated charcoal. In an embodiment, the gas-confining agent comprises activated carbon. In an embodiment, the gas-confining agent comprises porous silica. In an embodiment, the gas-confining agent comprises a molecular sieve.

In an embodiment, the gas-confining agent is from about 10% to about 98% by weight of the total composition. In an embodiment, the aqueous composition further comprises a water conditioning agent, a metal chelating agent, a pH controlling agent, a biocide, a preservative, a surfactant, a dispersant, a wetting agent, a spray adjuvant, a polymer, or any combination thereof. In an embodiment, the aqueous composition further comprises a fungicide, an insecticide, a herbicide, a fertilizer, a nutrient, or any combination thereof. In an embodiment, the solid composition is capable of dilution in water to form an aqueous composition.

In an illustrative aspect, a method of preparing an aqueous composition is provided. The method comprises the steps of a) adding water into a vessel, b) adding a gas-confining agent into the vessel, c) adding 1-MCP into the vessel, and d) mixing the water, the gas-confining agent, and the 1-MCP to form the aqueous composition.

In an embodiment, step c) is performed concurrently with step b). In an embodiment, step c) is performed after step b). In an embodiment, the mixing is performed until the aqueous composition is homogenous. Amongst the various embodiments, the aqueous composition can be a pre-mix composition in which the 1-MCP and the gas-confining agent are combined with the water at the point of use (e.g., a backpack application, a drone application, or the like). Alternatively, amongst the various embodiments, the aqueous composition can be a tank-mix composition in which the 1-MCP is combined with the gas-confining agent and the water at the point of use (e.g., a field-based).

In an embodiment, the 1-MCP is comprised in a complex. In an embodiment, the complex is an inclusion complex. In an embodiment, the inclusion complex comprises cyclodextrin. In an embodiment, the inclusion complex comprises alpha-cyclodextrin. In an embodiment, the inclusion complex consists essentially of alpha-cyclodextrin. In an embodiment, the inclusion complex consists of alpha-cyclodextrin.

In an embodiment, the gas-confining agent is derived from the inclusion complex. In an embodiment, the complex is suspended as solid particles in the aqueous composition. In an embodiment, the solid particle size is of an average between about 0.5 μm to about 30 μm.

In an embodiment, the complex is air milled. In an embodiment, the complex is solubilized in the aqueous composition. In an embodiment, the complex is present at a concentration from about 0.1% to about 50% by weight of the aqueous composition. In an embodiment, the complex is present at a concentration from about 0.5% to about 30% by weight of the aqueous composition. In an embodiment, the complex is present at a concentration from about 0.5% to about 20% by weight of the aqueous composition. In an embodiment, the complex is present at a concentration from about 0.5% to about 10% by weight of the aqueous composition.

In an embodiment, the 1-MCP is comprised in a solution. In an embodiment, the 1-MCP is present in the solution at about 0.1% to about 1.0%. In an embodiment, the 1-MCP is present in the solution at about 1% to about 2%. In an embodiment, the 1-MCP is present in the solution at about 2% to about 3%. In an embodiment, the 1-MCP is present in the solution at about 3% to about 4%. In an embodiment, the 1-MCP is present in the solution at about 4% to about 5%.

In an embodiment, the 1-MCP is present in the solution at about 1%. In an embodiment, the 1-MCP is present in the solution at about 1.1%. In an embodiment, the 1-MCP is present in the solution at about 1.2%. In an embodiment, the 1-MCP is present in the solution at about 1.3%. In an embodiment, the 1-MCP is present in the solution at about 1.4%. In an embodiment, the 1-MCP is present in the solution at about 1.5%. In an embodiment, the 1-MCP is present in the solution at about 1.6%. In an embodiment, the 1-MCP is present in the solution at about 1.7%. In an embodiment, the 1-MCP is present in the solution at about 1.8%. In an embodiment, the 1-MCP is present in the solution at about 1.9%. In an embodiment, the 1-MCP is present in the solution at about 2%. In an embodiment, the 1-MCP is present in the solution at about 2.1%. In an embodiment, the 1-MCP is present in the solution at about 2.2%. In an embodiment, the 1-MCP is present in the solution at about 2.3%. In an embodiment, the 1-MCP is present in the solution at about 2.4%. In an embodiment, the 1-MCP is present in the solution at about 2.5%. In an embodiment, the 1-MCP is present in the solution at about 2.6%. In an embodiment, the 1-MCP is present in the solution at about 2.7%. In an embodiment, the 1-MCP is present in the solution at about 2.8%. In an embodiment, the 1-MCP is present in the solution at about 2.9%. In an embodiment, the 1-MCP is present in the solution at about 3%. In an embodiment, the 1-MCP is present in the solution at about 3.1%. In an embodiment, the 1-MCP is present in the solution at about 3.2%. In an embodiment, the 1-MCP is present in the solution at about 3.3%. In an embodiment, the 1-MCP is present in the solution at about 3.4%. In an embodiment, the 1-MCP is present in the solution at about 3.5%. In an embodiment, the 1-MCP is present in the solution at about 3.6%. In an embodiment, the 1-MCP is present in the solution at about 3.7%. In an embodiment, the 1-MCP is present in the solution at about 3.8%. In an embodiment, the 1-MCP is present in the solution at about 3.9%. In an embodiment, the 1-MCP is present in the solution at about 4%. In an embodiment, the 1-MCP is present in the solution at about 4.1%. In an embodiment, the 1-MCP is present in the solution at about 4.2%. In an embodiment, the 1-MCP is present in the solution at about 4.3%. In an embodiment, the 1-MCP is present in the solution at about 4.4%. In an embodiment, the 1-MCP is present in the solution at about 4.5%. In an embodiment, the 1-MCP is present in the solution at about 4.6%. In an embodiment, the 1-MCP is present in the solution at about 4.7%. In an embodiment, the 1-MCP is present in the solution at about 4.8%. In an embodiment, the 1-MCP is present in the solution at about 4.9%. In an embodiment, the 1-MCP is present in the solution at about 5%.

In an embodiment, the 1-MCP is comprised in a powder. In an embodiment, the powder is a wettable powder. In an embodiment, the 1-MCP is present in the powder at about 0.1% to about 1.0%. In an embodiment, the 1-MCP is present in the powder at about 1% to about 2%. In an embodiment, the 1-MCP is present in the powder at about 2% to about 3%. In an embodiment, the 1-MCP is present in the powder at about 3% to about 4%. In an embodiment, the 1-MCP is present in the powder at about 4% to about 5%.

In an embodiment, the 1-MCP is present in the powder at about 1%. In an embodiment, the 1-MCP is present in the powder at about 1.1%. In an embodiment, the 1-MCP is present in the powder at about 1.2%. In an embodiment, the 1-MCP is present in the powder at about 1.3%. In an embodiment, the 1-MCP is present in the powder at about 1.4%. In an embodiment, the 1-MCP is present in the powder at about 1.5%. In an embodiment, the 1-MCP is present in the powder at about 1.6%. In an embodiment, the 1-MCP is present in the powder at about 1.7%. In an embodiment, the 1-MCP is present in the powder at about 1.8%. In an embodiment, the 1-MCP is present in the powder at about 1.9%. In an embodiment, the 1-MCP is present in the powder at about 2%. In an embodiment, the 1-MCP is present in the powder at about 2.1%. In an embodiment, the 1-MCP is present in the powder at about 2.2%. In an embodiment, the 1-MCP is present in the powder at about 2.3%. In an embodiment, the 1-MCP is present in the powder at about 2.4%. In an embodiment, the 1-MCP is present in the powder at about 2.5%. In an embodiment, the 1-MCP is present in the powder at about 2.6%. In an embodiment, the 1-MCP is present in the powder at about 2.7%. In an embodiment, the 1-MCP is present in the powder at about 2.8%. In an embodiment, the 1-MCP is present in the powder at about 2.9%. In an embodiment, the 1-MCP is present in the powder at about 3%. In an embodiment, the 1-MCP is present in the powder at about 3.1%. In an embodiment, the 1-MCP is present in the powder at about 3.2%. In an embodiment, the 1-MCP is present in the powder at about 3.3%. In an embodiment, the 1-MCP is present in the powder at about 3.4%. In an embodiment, the 1-MCP is present in the powder at about 3.5%. In an embodiment, the 1-MCP is present in the powder at about 3.6%. In an embodiment, the 1-MCP is present in the powder at about 3.7%. In an embodiment, the 1-MCP is present in the powder at about 3.8%. In an embodiment, the 1-MCP is present in the powder at about 3.9%. In an embodiment, the 1-MCP is present in the powder at about 4%. In an embodiment, the 1-MCP is present in the powder at about 4.1%. In an embodiment, the 1-MCP is present in the powder at about 4.2%. In an embodiment, the 1-MCP is present in the powder at about 4.3%. In an embodiment, the 1-MCP is present in the powder at about 4.4%. In an embodiment, the 1-MCP is present in the powder at about 4.5%. In an embodiment, the 1-MCP is present in the powder at about 4.6%. In an embodiment, the 1-MCP is present in the powder at about 4.7%. In an embodiment, the 1-MCP is present in the powder at about 4.8%. In an embodiment, the 1-MCP is present in the powder at about 4.9%. In an embodiment, the 1-MCP is present in the powder at about 5%.

In an embodiment, the gas-confining agent is selected from the group consisting of alpha cyclodextrin, activated charcoal, activated carbon, porous silica, molecular sieve, and any combination thereof. In an embodiment, the gas-confining agent comprises alpha cyclodextrin. In an embodiment, the gas-confining agent comprises activated charcoal. In an embodiment, the gas-confining agent comprises activated carbon. In an embodiment, the gas-confining agent comprises porous silica. In an embodiment, the gas-confining agent comprises a molecular sieve.

In an embodiment, the gas-confining agent is from about 0.1% to about 50% by weight of the water in the aqueous composition. In an embodiment, the gas-confining agent is from about 1% to about 30% by weight of the water in the aqueous composition. In an embodiment, the gas-confining agent is from about 2% to about 20% by weight of the water in the aqueous composition. In an embodiment, the gas-confining agent is from about 2.5% to about 15% by weight of the water in the aqueous composition. In an embodiment, the gas-sequestering agent is from about 1% to about 10% by weight of the water in the aqueous composition. In an embodiment, the gas-sequestering agent is from about 3% to about 10% by weight of the water in the aqueous composition. In an embodiment, the gas-sequestering agent is about 1% by weight of the water in the aqueous composition. In an embodiment, the gas-sequestering agent is about 2% by weight of the water in the aqueous composition. In an embodiment, the gas-sequestering agent is about 3% by weight of the water in the aqueous composition. In an embodiment, the gas-sequestering agent is about 4% by weight of the water in the aqueous composition. In an embodiment, the gas-sequestering agent is about 5% by weight of the water in the aqueous composition. In an embodiment, the gas-sequestering agent is about 6% by weight of the water in the aqueous composition. In an embodiment, the gas-sequestering agent is about 7% by weight of the water in the aqueous composition. In an embodiment, the gas-sequestering agent is about 8% by weight of the water in the aqueous composition. In an embodiment, the gas-sequestering agent is about 9% by weight of the water in the aqueous composition. In an embodiment, the gas-sequestering agent is about 10% by weight of the water in the aqueous composition. In an embodiment, the gas-sequestering agent is about 11% by weight of the water in the aqueous composition. In an embodiment, the gas-sequestering agent is about 12% by weight of the water in the aqueous composition. In an embodiment, the gas-sequestering agent is about 13% by weight of the water in the aqueous composition. In an embodiment, the gas-sequestering agent is about 14% by weight of the water in the aqueous composition. In an embodiment, the gas-sequestering agent is about 15% by weight of the water in the aqueous composition.

In an embodiment, the aqueous composition further comprises a water conditioning agent, a metal chelating agent, a pH controlling agent, a biocide, a preservative, a surfactant, a dispersant, a wetting agent, a spray adjuvant, a polymer, or any combination thereof. In an embodiment, the aqueous composition further comprises a fungicide, an insecticide, a herbicide, a fertilizer, a nutrient, or any combination thereof.

In an illustrative aspect, a method of preparing solid composition is provided. The method comprises the steps of a) adding a gas-confining agent into a vessel, b) adding 1-MCP into the vessel, and c) blending the gas-confining agent and the 1-MCP to form the sold composition.

In an embodiment, the blending is performed until the solid composition is homogenous.

In an embodiment, the 1-MCP is comprised in a complex. In an embodiment, the complex is an inclusion complex. In an embodiment, the inclusion complex comprises cyclodextrin. In an embodiment, the inclusion complex comprises alpha-cyclodextrin. In an embodiment, the inclusion complex consists essentially of alpha-cyclodextrin. In an embodiment, the inclusion complex consists of alpha-cyclodextrin.

In an embodiment, the gas-confining agent is derived from the inclusion complex. In an embodiment, the complex is present as solid particles in the solid composition. In an embodiment, the solid particle size is of an average between about 0.5 μm to about 30 μm.

In an embodiment, the complex is air milled. In an embodiment, the complex is from about 2% to about 90% by weight of the total composition.

In an embodiment, the 1-MCP is comprised in a powder. In an embodiment, the powder is a wettable powder. In an embodiment, the 1-MCP is present in the powder at about 0.1% to about 1.0%. In an embodiment, the 1-MCP is present in the powder at about 1% to about 2%. In an embodiment, the 1-MCP is present in the powder at about 2% to about 3%. In an embodiment, the 1-MCP is present in the powder at about 3% to about 4%. In an embodiment, the 1-MCP is present in the powder at about 4% to about 5%.

In an embodiment, the 1-MCP is present in the powder at about 1%. In an embodiment, the 1-MCP is present in the powder at about 1.1%. In an embodiment, the 1-MCP is present in the powder at about 1.2%. In an embodiment, the 1-MCP is present in the powder at about 1.3%. In an embodiment, the 1-MCP is present in the powder at about 1.4%. In an embodiment, the 1-MCP is present in the powder at about 1.5%. In an embodiment, the 1-MCP is present in the powder at about 1.6%. In an embodiment, the 1-MCP is present in the powder at about 1.7%. In an embodiment, the 1-MCP is present in the powder at about 1.8%. In an embodiment, the 1-MCP is present in the powder at about 1.9%. In an embodiment, the 1-MCP is present in the powder at about 2%. In an embodiment, the 1-MCP is present in the powder at about 2.1%. In an embodiment, the 1-MCP is present in the powder at about 2.2%. In an embodiment, the 1-MCP is present in the powder at about 2.3%. In an embodiment, the 1-MCP is present in the powder at about 2.4%. In an embodiment, the 1-MCP is present in the powder at about 2.5%. In an embodiment, the 1-MCP is present in the powder at about 2.6%. In an embodiment, the 1-MCP is present in the powder at about 2.7%. In an embodiment, the 1-MCP is present in the powder at about 2.8%. In an embodiment, the 1-MCP is present in the powder at about 2.9%. In an embodiment, the 1-MCP is present in the powder at about 3%. In an embodiment, the 1-MCP is present in the powder at about 3.1%. In an embodiment, the 1-MCP is present in the powder at about 3.2%. In an embodiment, the 1-MCP is present in the powder at about 3.3%. In an embodiment, the 1-MCP is present in the powder at about 3.4%. In an embodiment, the 1-MCP is present in the powder at about 3.5%. In an embodiment, the 1-MCP is present in the powder at about 3.6%. In an embodiment, the 1-MCP is present in the powder at about 3.7%. In an embodiment, the 1-MCP is present in the powder at about 3.8%. In an embodiment, the 1-MCP is present in the powder at about 3.9%. In an embodiment, the 1-MCP is present in the powder at about 4%. In an embodiment, the 1-MCP is present in the powder at about 4.1%. In an embodiment, the 1-MCP is present in the powder at about 4.2%. In an embodiment, the 1-MCP is present in the powder at about 4.3%. In an embodiment, the 1-MCP is present in the powder at about 4.4%. In an embodiment, the 1-MCP is present in the powder at about 4.5%. In an embodiment, the 1-MCP is present in the powder at about 4.6%. In an embodiment, the 1-MCP is present in the powder at about 4.7%. In an embodiment, the 1-MCP is present in the powder at about 4.8%. In an embodiment, the 1-MCP is present in the powder at about 4.9%. In an embodiment, the 1-MCP is present in the powder at about 5%.

In an embodiment, the gas-confining agent is selected from the group consisting of alpha cyclodextrin, activated charcoal, activated carbon, porous silica, molecular sieve, and any combination thereof. In an embodiment, the gas-confining agent comprises alpha cyclodextrin. In an embodiment, the gas-confining agent comprises activated charcoal. In an embodiment, the gas-confining agent comprises activated carbon. In an embodiment, the gas-confining agent comprises porous silica. In an embodiment, the gas-confining agent comprises a molecular sieve.

In an embodiment, the gas-confining agent is from about 10% to about 98% by weight of the total composition. In an embodiment, the solid composition further comprises a water conditioning agent, a metal chelating agent, a pH controlling agent, a biocide, a preservative, a surfactant, a dispersant, a wetting agent, a spray adjuvant, a polymer, or any combination thereof. In an embodiment, the solid composition further comprises a fungicide, an insecticide, a herbicide, a fertilizer, a nutrient, or any combination thereof.

In an embodiment, the solid composition is a granule blend. In an embodiment, the solid composition is a powder blend. In an embodiment, the powder blend is capable of granulation.

In an illustrative aspect, a method of applying an aqueous composition to a plant or plant part is provided. The method comprises the step of administering the aqueous composition to the plant or plant part via farm equipment.

In an embodiment, the farm equipment comprises ground spray equipment. In an embodiment, the farm equipment comprises aerial spray equipment. In an embodiment, the farm equipment comprises drone spray equipment. In an embodiment, the farm equipment comprises backpack spray equipment.

In an embodiment, the farm equipment comprises a spray tank or vessel. In an embodiment, the spray tank or vessel is vented.

In an embodiment, the aqueous composition is prepared in-situ. In an embodiment, the aqueous composition is the aqueous composition according to any aqueous composition described herein. In an embodiment, the aqueous composition is the prepared according to any of the methods described herein.

The following numbered embodiments are contemplated and are non-limiting.

1. An aqueous composition comprising i) 1-MCP, ii) a gas-sequestering agent, and iii) water.

2. The aqueous composition of clause 1, any other suitable clause, or any combination of suitable clauses, wherein the 1-MCP is comprised in a complex.

3. The aqueous composition of clause 2, any other suitable clause, or any combination of suitable clauses, wherein the complex is an inclusion complex.

4. The aqueous composition of clause 3, any other suitable clause, or any combination of suitable clauses, wherein the inclusion complex comprises cyclodextrin.

5. The aqueous composition of clause 3, any other suitable clause, or any combination of suitable clauses, wherein the inclusion complex comprises alpha-cyclodextrin.

6. The aqueous composition of clause 3, any other suitable clause, or any combination of suitable clauses, wherein the inclusion complex consists essentially of alpha-cyclodextrin.

7. The aqueous composition of clause 3, any other suitable clause, or any combination of suitable clauses, wherein the inclusion complex consists of alpha-cyclodextrin.

8. The aqueous composition of clause 3, any other suitable clause, or any combination of suitable clauses, wherein the gas-sequestering agent is derived from the inclusion complex.

9. The aqueous composition of clause 2, any other suitable clause, or any combination of suitable clauses, wherein the complex is suspended as solid particles in the aqueous composition.

10. The aqueous composition of clause 9, any other suitable clause, or any combination of suitable clauses, wherein the solid particle size is of an average between about 0.5 μm to about 30 μm.

11. The aqueous composition of clause 2, any other suitable clause, or any combination of suitable clauses, wherein the complex is air milled.

12. The aqueous composition of clause 2, any other suitable clause, or any combination of suitable clauses, wherein the complex is solubilized in the aqueous composition.

13. The aqueous composition of clause 2, any other suitable clause, or any combination of suitable clauses, wherein the complex is present at a concentration from about 0.1% to about 50% by weight of the aqueous composition.

14. The aqueous composition of clause 2, any other suitable clause, or any combination of suitable clauses, wherein the complex is present at a concentration from about 0.5% to about 30% by weight of the aqueous composition.

15. The aqueous composition of clause 2, any other suitable clause, or any combination of suitable clauses, wherein the complex is present at a concentration from about 0.5% to about 20% by weight of the aqueous composition.

16. The aqueous composition of clause 2, any other suitable clause, or any combination of suitable clauses, wherein the complex is present at a concentration from about 0.5% to about 10% by weight of the aqueous composition.

17. The aqueous composition of clause 1, any other suitable clause, or any combination of suitable clauses, wherein the 1-MCP is comprised in a solution.

18. The aqueous composition of clause 17, any other suitable clause, or any combination of suitable clauses, wherein the 1-MCP is present in the solution at about 0.1% to about 1.0%.

19. The aqueous composition of clause 17, any other suitable clause, or any combination of suitable clauses, wherein the 1-MCP is present in the solution at about 1% to about 2%.

20. The aqueous composition of clause 17, any other suitable clause, or any combination of suitable clauses, wherein the 1-MCP is present in the solution at about 2% to about 3%.

21. The aqueous composition of clause 17, any other suitable clause, or any combination of suitable clauses, wherein the 1-MCP is present in the solution at about 3% to about 4%.

22. The aqueous composition of clause 17, any other suitable clause, or any combination of suitable clauses, wherein the 1-MCP is present in the solution at about 4% to about 5%.

23. The aqueous composition of clause 17, any other suitable clause, or any combination of suitable clauses, wherein the 1-MCP is present in the solution at about 1%.

24. The aqueous composition of clause 17, any other suitable clause, or any combination of suitable clauses, wherein the 1-MCP is present in the solution at about 1.1%.

25. The aqueous composition of clause 17, any other suitable clause, or any combination of suitable clauses, wherein the 1-MCP is present in the solution at about 1.2%.

26. The aqueous composition of clause 17, any other suitable clause, or any combination of suitable clauses, wherein the 1-MCP is present in the solution at about 1.3%.

27. The aqueous composition of clause 17, any other suitable clause, or any combination of suitable clauses, wherein the 1-MCP is present in the solution at about 1.4%.

28. The aqueous composition of clause 17, any other suitable clause, or any combination of suitable clauses, wherein the 1-MCP is present in the solution at about 1.5%.

29. The aqueous composition of clause 17, any other suitable clause, or any combination of suitable clauses, wherein the 1-MCP is present in the solution at about 1.6%.

30. The aqueous composition of clause 17, any other suitable clause, or any combination of suitable clauses, wherein the 1-MCP is present in the solution at about 1.7%.

31. The aqueous composition of clause 17, any other suitable clause, or any combination of suitable clauses, wherein the 1-MCP is present in the solution at about 1.8%.

32. The aqueous composition of clause 17, any other suitable clause, or any combination of suitable clauses, wherein the 1-MCP is present in the solution at about 1.9%.

33. The aqueous composition of clause 17, any other suitable clause, or any combination of suitable clauses, wherein the 1-MCP is present in the solution at about 2%.

34. The aqueous composition of clause 17, any other suitable clause, or any combination of suitable clauses, wherein the 1-MCP is present in the solution at about 2.1%.

35. The aqueous composition of clause 17, any other suitable clause, or any combination of suitable clauses, wherein the 1-MCP is present in the solution at about 2.2%.

36. The aqueous composition of clause 17, any other suitable clause, or any combination of suitable clauses, wherein the 1-MCP is present in the solution at about 2.3%.

37. The aqueous composition of clause 17, any other suitable clause, or any combination of suitable clauses, wherein the 1-MCP is present in the solution at about 2.4%.

38. The aqueous composition of clause 17, any other suitable clause, or any combination of suitable clauses, wherein the 1-MCP is present in the solution at about 2.5%.

39. The aqueous composition of clause 17, any other suitable clause, or any combination of suitable clauses, wherein the 1-MCP is present in the solution at about 2.6%.

40. The aqueous composition of clause 17, any other suitable clause, or any combination of suitable clauses, wherein the 1-MCP is present in the solution at about 2.7%.

41. The aqueous composition of clause 17, any other suitable clause, or any combination of suitable clauses, wherein the 1-MCP is present in the solution at about 2.8%.

42. The aqueous composition of clause 17, any other suitable clause, or any combination of suitable clauses, wherein the 1-MCP is present in the solution at about 2.9%.

43. The aqueous composition of clause 17, any other suitable clause, or any combination of suitable clauses, wherein the 1-MCP is present in the solution at about 3%.

44. The aqueous composition of clause 17, any other suitable clause, or any combination of suitable clauses, wherein the 1-MCP is present in the solution at about 3.1%.

45. The aqueous composition of clause 17, any other suitable clause, or any combination of suitable clauses, wherein the 1-MCP is present in the solution at about 3.2%.

46. The aqueous composition of clause 17, any other suitable clause, or any combination of suitable clauses, wherein the 1-MCP is present in the solution at about 3.3%.

47. The aqueous composition of clause 17, any other suitable clause, or any combination of suitable clauses, wherein the 1-MCP is present in the solution at about 3.4%.

48. The aqueous composition of clause 17, any other suitable clause, or any combination of suitable clauses, wherein the 1-MCP is present in the solution at about 3.5%.

49. The aqueous composition of clause 17, any other suitable clause, or any combination of suitable clauses, wherein the 1-MCP is present in the solution at about 3.6%.

50. The aqueous composition of clause 17, any other suitable clause, or any combination of suitable clauses, wherein the 1-MCP is present in the solution at about 3.7%.

51. The aqueous composition of clause 17, any other suitable clause, or any combination of suitable clauses, wherein the 1-MCP is present in the solution at about 3.8%.

52. The aqueous composition of clause 17, any other suitable clause, or any combination of suitable clauses, wherein the 1-MCP is present in the solution at about 3.9%.

53. The aqueous composition of clause 17, any other suitable clause, or any combination of suitable clauses, wherein the 1-MCP is present in the solution at about 4%.

54. The aqueous composition of clause 17, any other suitable clause, or any combination of suitable clauses, wherein the 1-MCP is present in the solution at about 4.1%.

55. The aqueous composition of clause 17, any other suitable clause, or any combination of suitable clauses, wherein the 1-MCP is present in the solution at about 4.2%.

56. The aqueous composition of clause 17, any other suitable clause, or any combination of suitable clauses, wherein the 1-MCP is present in the solution at about 4.3%.

57. The aqueous composition of clause 17, any other suitable clause, or any combination of suitable clauses, wherein the 1-MCP is present in the solution at about 4.4%.

58. The aqueous composition of clause 17, any other suitable clause, or any combination of suitable clauses, wherein the 1-MCP is present in the solution at about 4.5%.

59. The aqueous composition of clause 17, any other suitable clause, or any combination of suitable clauses, wherein the 1-MCP is present in the solution at about 4.6%.

60. The aqueous composition of clause 17, any other suitable clause, or any combination of suitable clauses, wherein the 1-MCP is present in the solution at about 4.7%.

61. The aqueous composition of clause 17, any other suitable clause, or any combination of suitable clauses, wherein the 1-MCP is present in the solution at about 4.8%.

62. The aqueous composition of clause 17, any other suitable clause, or any combination of suitable clauses, wherein the 1-MCP is present in the solution at about 4.9%.

63. The aqueous composition of clause 17, any other suitable clause, or any combination of suitable clauses, wherein the 1-MCP is present in the solution at about 5%.

64. The aqueous composition of clause 1, any other suitable clause, or any combination of suitable clauses, wherein the 1-MCP is comprised in a powder.

65. The aqueous composition of clause 64, any other suitable clause, or any combination of suitable clauses, wherein the powder is a wettable powder.

66. The aqueous composition of clause 64, any other suitable clause, or any combination of suitable clauses, wherein the 1-MCP is present in the powder at about 0.1% to about 1.0%.

67. The aqueous composition of clause 64, any other suitable clause, or any combination of suitable clauses, wherein the 1-MCP is present in the powder at about 1% to about 2%.

68. The aqueous composition of clause 64, any other suitable clause, or any combination of suitable clauses, wherein the 1-MCP is present in the powder at about 2% to about 3%.

69. The aqueous composition of clause 64, any other suitable clause, or any combination of suitable clauses, wherein the 1-MCP is present in the powder at about 3% to about 4%.

70. The aqueous composition of clause 64, any other suitable clause, or any combination of suitable clauses, wherein the 1-MCP is present in the powder at about 4% to about 5%.

71. The aqueous composition of clause 64, any other suitable clause, or any combination of suitable clauses, wherein the 1-MCP is present in the powder at about 1%.

72. The aqueous composition of clause 64, any other suitable clause, or any combination of suitable clauses, wherein the 1-MCP is present in the powder at about 1.1%.

73. The aqueous composition of clause 64, any other suitable clause, or any combination of suitable clauses, wherein the 1-MCP is present in the powder at about 1.2%.

74. The aqueous composition of clause 64, any other suitable clause, or any combination of suitable clauses, wherein the 1-MCP is present in the powder at about 1.3%.

75. The aqueous composition of clause 64, any other suitable clause, or any combination of suitable clauses, wherein the 1-MCP is present in the powder at about 1.4%.

76. The aqueous composition of clause 64, any other suitable clause, or any combination of suitable clauses, wherein the 1-MCP is present in the powder at about 1.5%.

77. The aqueous composition of clause 64, any other suitable clause, or any combination of suitable clauses, wherein the 1-MCP is present in the powder at about 1.6%.

78. The aqueous composition of clause 64, any other suitable clause, or any combination of suitable clauses, wherein the 1-MCP is present in the powder at about 1.7%.

79. The aqueous composition of clause 64, any other suitable clause, or any combination of suitable clauses, wherein the 1-MCP is present in the powder at about 1.8%.

80. The aqueous composition of clause 64, any other suitable clause, or any combination of suitable clauses, wherein the 1-MCP is present in the powder at about 1.9%.

81. The aqueous composition of clause 64, any other suitable clause, or any combination of suitable clauses, wherein the 1-MCP is present in the powder at about 2%.

82. The aqueous composition of clause 64, any other suitable clause, or any combination of suitable clauses, wherein the 1-MCP is present in the powder at about 2.1%.

83. The aqueous composition of clause 64, any other suitable clause, or any combination of suitable clauses, wherein the 1-MCP is present in the powder at about 2.2%.

84. The aqueous composition of clause 64, any other suitable clause, or any combination of suitable clauses, wherein the 1-MCP is present in the powder at about 2.3%.

85. The aqueous composition of clause 64, any other suitable clause, or any combination of suitable clauses, wherein the 1-MCP is present in the powder at about 2.4%.

86. The aqueous composition of clause 64, any other suitable clause, or any combination of suitable clauses, wherein the 1-MCP is present in the powder at about 2.5%.

87. The aqueous composition of clause 64, any other suitable clause, or any combination of suitable clauses, wherein the 1-MCP is present in the powder at about 2.6%.

88. The aqueous composition of clause 64, any other suitable clause, or any combination of suitable clauses, wherein the 1-MCP is present in the powder at about 2.7%.

89. The aqueous composition of clause 64, any other suitable clause, or any combination of suitable clauses, wherein the 1-MCP is present in the powder at about 2.8%.

90. The aqueous composition of clause 64, any other suitable clause, or any combination of suitable clauses, wherein the 1-MCP is present in the powder at about 2.9%.

91. The aqueous composition of clause 64, any other suitable clause, or any combination of suitable clauses, wherein the 1-MCP is present in the powder at about 3%.

92. The aqueous composition of clause 64, any other suitable clause, or any combination of suitable clauses, wherein the 1-MCP is present in the powder at about 3.1%.

93. The aqueous composition of clause 64, any other suitable clause, or any combination of suitable clauses, wherein the 1-MCP is present in the powder at about 3.2%.

94. The aqueous composition of clause 64, any other suitable clause, or any combination of suitable clauses, wherein the 1-MCP is present in the powder at about 3.3%.

95. The aqueous composition of clause 64, any other suitable clause, or any combination of suitable clauses, wherein the 1-MCP is present in the powder at about 3.4%.

96. The aqueous composition of clause 64, any other suitable clause, or any combination of suitable clauses, wherein the 1-MCP is present in the powder at about 3.5%.

97. The aqueous composition of clause 64, any other suitable clause, or any combination of suitable clauses, wherein the 1-MCP is present in the powder at about 3.6%.

98. The aqueous composition of clause 64, any other suitable clause, or any combination of suitable clauses, wherein the 1-MCP is present in the powder at about 3.7%.

99. The aqueous composition of clause 64, any other suitable clause, or any combination of suitable clauses, wherein the 1-MCP is present in the powder at about 3.8%.

100. The aqueous composition of clause 64, any other suitable clause, or any combination of suitable clauses, wherein the 1-MCP is present in the powder at about 3.9%.

101. The aqueous composition of clause 64, any other suitable clause, or any combination of suitable clauses, wherein the 1-MCP is present in the powder at about 4%.

102. The aqueous composition of clause 64, any other suitable clause, or any combination of suitable clauses, wherein the 1-MCP is present in the powder at about 4.1%.

103. The aqueous composition of clause 64, any other suitable clause, or any combination of suitable clauses, wherein the 1-MCP is present in the powder at about 4.2%.

104. The aqueous composition of clause 64, any other suitable clause, or any combination of suitable clauses, wherein the 1-MCP is present in the powder at about 4.3%.

105. The aqueous composition of clause 64, any other suitable clause, or any combination of suitable clauses, wherein the 1-MCP is present in the powder at about 4.4%.

106. The aqueous composition of clause 64, any other suitable clause, or any combination of suitable clauses, wherein the 1-MCP is present in the powder at about 4.5%.

107. The aqueous composition of clause 64, any other suitable clause, or any combination of suitable clauses, wherein the 1-MCP is present in the powder at about 4.6%.

108. The aqueous composition of clause 64, any other suitable clause, or any combination of suitable clauses, wherein the 1-MCP is present in the powder at about 4.7%.

109. The aqueous composition of clause 64, any other suitable clause, or any combination of suitable clauses, wherein the 1-MCP is present in the powder at about 4.8%.

110. The aqueous composition of clause 64, any other suitable clause, or any combination of suitable clauses, wherein the 1-MCP is present in the powder at about 4.9%.

111. The aqueous composition of clause 64, any other suitable clause, or any combination of suitable clauses, wherein the 1-MCP is present in the powder at about 5%.

112. The aqueous composition of clause 1, any other suitable clause, or any combination of suitable clauses, wherein the gas-sequestering agent is selected from the group consisting of alpha cyclodextrin, activated charcoal, activated carbon, porous silica, molecular sieve, and any combination thereof.

113. The aqueous composition of clause 1, any other suitable clause, or any combination of suitable clauses, wherein the gas-sequestering agent comprises alpha cyclodextrin.

114. The aqueous composition of clause 1, any other suitable clause, or any combination of suitable clauses, wherein the gas-sequestering agent comprises activated charcoal.

115. The aqueous composition of clause 1, any other suitable clause, or any combination of suitable clauses, wherein the gas-sequestering agent comprises activated carbon.

116. The aqueous composition of clause 1, any other suitable clause, or any combination of suitable clauses, wherein the gas-sequestering agent comprises porous silica.

117. The aqueous composition of clause 1, any other suitable clause, or any combination of suitable clauses, wherein the gas-sequestering agent comprises a molecular sieve.

118. The aqueous composition of clause 1, any other suitable clause, or any combination of suitable clauses, wherein the gas-sequestering agent is from about 0.1% to about 50% by weight of the water in the aqueous composition.

119. The aqueous composition of clause 1, any other suitable clause, or any combination of suitable clauses, wherein the gas-sequestering agent is from about 1% to about 30% by weight of the water in the aqueous composition.

120. The aqueous composition of clause 1, any other suitable clause, or any combination of suitable clauses, wherein the gas-sequestering agent is from about 2% to about 20% by weight of the water in the aqueous composition.

121. The aqueous composition of clause 1, any other suitable clause, or any combination of suitable clauses, wherein the gas-sequestering agent is from about 2.5% to about 15% by weight of the water in the aqueous composition.

122. The aqueous composition of clause 1, any other suitable clause, or any combination of suitable clauses, wherein the gas-sequestering agent is from about 1% to about 10% by weight of the water in the aqueous composition.

123. The aqueous composition of clause 1, any other suitable clause, or any combination of suitable clauses, wherein the gas-sequestering agent is from about 3% to about 10% by weight of the water in the aqueous composition.

124. The aqueous composition of clause 1, any other suitable clause, or any combination of suitable clauses, wherein the gas-sequestering agent is about 1% by weight of the water in the aqueous composition.

125. The aqueous composition of clause 1, any other suitable clause, or any combination of suitable clauses, wherein the gas-sequestering agent is about 2% by weight of the water in the aqueous composition.

126. The aqueous composition of clause 1, any other suitable clause, or any combination of suitable clauses, wherein the gas-sequestering agent is about 3% by weight of the water in the aqueous composition.

127. The aqueous composition of clause 1, any other suitable clause, or any combination of suitable clauses, wherein the gas-sequestering agent is about 4% by weight of the water in the aqueous composition.

128. The aqueous composition of clause 1, any other suitable clause, or any combination of suitable clauses, wherein the gas-sequestering agent is about 5% by weight of the water in the aqueous composition.

129. The aqueous composition of clause 1, any other suitable clause, or any combination of suitable clauses, wherein the gas-sequestering agent is about 6% by weight of the water in the aqueous composition.

130. The aqueous composition of clause 1, any other suitable clause, or any combination of suitable clauses, wherein the gas-sequestering agent is about 7% by weight of the water in the aqueous composition.

131. The aqueous composition of clause 1, any other suitable clause, or any combination of suitable clauses, wherein the gas-sequestering agent is about 8% by weight of the water in the aqueous composition.

132. The aqueous composition of clause 1, any other suitable clause, or any combination of suitable clauses, wherein the gas-sequestering agent is about 9% by weight of the water in the aqueous composition.

133. The aqueous composition of clause 1, any other suitable clause, or any combination of suitable clauses, wherein the gas-sequestering agent is about 10% by weight of the water in the aqueous composition.

134. The aqueous composition of clause 1, any other suitable clause, or any combination of suitable clauses, wherein the gas-sequestering agent is about 11% by weight of the water in the aqueous composition.

135. The aqueous composition of clause 1, any other suitable clause, or any combination of suitable clauses, wherein the gas-sequestering agent is about 12% by weight of the water in the aqueous composition.

136. The aqueous composition of clause 1, any other suitable clause, or any combination of suitable clauses, wherein the gas-sequestering agent is about 13% by weight of the water in the aqueous composition.

137. The aqueous composition of clause 1, any other suitable clause, or any combination of suitable clauses, wherein the gas-sequestering agent is about 14% by weight of the water in the aqueous composition.

138. The aqueous composition of clause 1, any other suitable clause, or any combination of suitable clauses, wherein the gas-sequestering agent is about 15% by weight of the water in the aqueous composition.

139 The aqueous composition of clause 1, any other suitable clause, or any combination of suitable clauses, wherein the total amount of 1-MCP in the aqueous composition is retained at least 10% by weight of the initial amount of 1-MCP over a period of 24 hours.

140 The aqueous composition of clause 1, any other suitable clause, or any combination of suitable clauses, wherein the total amount of 1-MCP in the aqueous composition is retained at least 25% by weight of the initial amount of 1-MCP over a period of 24 hours.

141. The aqueous composition of clause 1, any other suitable clause, or any combination of suitable clauses, wherein the total amount of 1-MCP in the aqueous composition is retained at least 50% by weight of the initial amount of 1-MCP over a period of 24 hours.

142. The aqueous composition of clause 1, any other suitable clause, or any combination of suitable clauses, wherein the total amount of 1-MCP in the aqueous composition is retained at least 75% by weight of the initial amount of 1-MCP over a period of 24 hours.

143. The aqueous composition of clause 1, any other suitable clause, or any combination of suitable clauses, wherein the aqueous composition further comprises a water conditioning agent, a metal chelating agent, a pH controlling agent, a biocide, a preservative, a surfactant, a dispersant, a wetting agent, a spray adjuvant, a polymer, or any combination thereof.

144. The aqueous composition of clause 1, any other suitable clause, or any combination of suitable clauses, wherein the aqueous composition further comprises a fungicide, an insecticide, a herbicide, a fertilizer, a nutrient, or any combination thereof.

145. A solid composition comprising i) 1-MCP and ii) a gas-sequestering agent.

146. The solid composition of clause 145, any other suitable clause, or any combination of suitable clauses, wherein the 1-MCP is comprised in a complex.

147 The solid composition of clause 146, any other suitable clause, or any combination of suitable clauses, wherein the complex is an inclusion complex.

148. The solid composition of clause 147, any other suitable clause, or any combination of suitable clauses, wherein the inclusion complex comprises cyclodextrin.

149. The solid composition of clause 147, any other suitable clause, or any combination of suitable clauses, wherein the inclusion complex comprises alpha-cyclodextrin.

150. The solid composition of clause 147, any other suitable clause, or any combination of suitable clauses, wherein the inclusion complex consists essentially of alpha-cyclodextrin.

151. The solid composition of clause 147, any other suitable clause, or any combination of suitable clauses, wherein the inclusion complex consists of alpha-cyclodextrin.

152. The solid composition of clause 147, any other suitable clause, or any combination of suitable clauses, wherein the gas-sequestering agent is derived from the inclusion complex.

153. The solid composition of clause 146, any other suitable clause, or any combination of suitable clauses, wherein the complex is present as solid particles in the solid composition.

154. The solid composition of clause 153, any other suitable clause, or any combination of suitable clauses, wherein the solid particle size is of an average between about 0.5 μm to about 30 μm.

155. The solid composition of clause 146, any other suitable clause, or any combination of suitable clauses, wherein the complex is air milled.

156. The solid composition of clause 146, any other suitable clause, or any combination of suitable clauses, wherein the complex is from about 2% to about 90% by weight of the total composition.

157. The solid composition of clause 145, any other suitable clause, or any combination of suitable clauses, wherein the 1-MCP is comprised in a powder.

158. The solid composition of clause 157, any other suitable clause, or any combination of suitable clauses, wherein the powder is a wettable powder.

159. The solid composition of clause 157, any other suitable clause, or any combination of suitable clauses, wherein the 1-MCP is present in the powder at about 0.1% to about 1.0%.

160 The solid composition of clause 157, any other suitable clause, or any combination of suitable clauses, wherein the 1-MCP is present in the powder at about 1% to about 2%.

161. The solid composition of clause 157, any other suitable clause, or any combination of suitable clauses, wherein the 1-MCP is present in the powder at about 2% to about 3%.

162. The solid composition of clause 157, any other suitable clause, or any combination of suitable clauses, wherein the 1-MCP is present in the powder at about 3% to about 4%.

163. The solid composition of clause 157, any other suitable clause, or any combination of suitable clauses, wherein the 1-MCP is present in the powder at about 4% to about 5%.

164. The solid composition of clause 157, any other suitable clause, or any combination of suitable clauses, wherein the 1-MCP is present in the powder at about 1%. 165. The solid composition of clause 157, any other suitable clause, or any combination of suitable clauses, wherein the 1-MCP is present in the powder at about 1.1%.

166. The solid composition of clause 157, any other suitable clause, or any combination of suitable clauses, wherein the 1-MCP is present in the powder at about 1.2%.

167. The solid composition of clause 157, any other suitable clause, or any combination of suitable clauses, wherein the 1-MCP is present in the powder at about 1.3%.

168. The solid composition of clause 157, any other suitable clause, or any combination of suitable clauses, wherein the 1-MCP is present in the powder at about 1.4%.

169. The solid composition of clause 157, any other suitable clause, or any combination of suitable clauses, wherein the 1-MCP is present in the powder at about 1.5%.

170. The solid composition of clause 157, any other suitable clause, or any combination of suitable clauses, wherein the 1-MCP is present in the powder at about 1.6%.

171. The solid composition of clause 157, any other suitable clause, or any combination of suitable clauses, wherein the 1-MCP is present in the powder at about 1.7%.

172. The solid composition of clause 157, any other suitable clause, or any combination of suitable clauses, wherein the 1-MCP is present in the powder at about 1.8%.

173. The solid composition of clause 157, any other suitable clause, or any combination of suitable clauses, wherein the 1-MCP is present in the powder at about 1.9%.

174. The solid composition of clause 157, any other suitable clause, or any combination of suitable clauses, wherein the 1-MCP is present in the powder at about 2%.

175. The solid composition of clause 157, any other suitable clause, or any combination of suitable clauses, wherein the 1-MCP is present in the powder at about 2.1%.

176 The solid composition of clause 157, any other suitable clause, or any combination of suitable clauses, wherein the 1-MCP is present in the powder at about 2.2%.

177. The solid composition of clause 157, any other suitable clause, or any combination of suitable clauses, wherein the 1-MCP is present in the powder at about 2.3%.

178. The solid composition of clause 157, any other suitable clause, or any combination of suitable clauses, wherein the 1-MCP is present in the powder at about 2.4%.

179. The solid composition of clause 157, any other suitable clause, or any combination of suitable clauses, wherein the 1-MCP is present in the powder at about 2.5%.

180. The solid composition of clause 157, any other suitable clause, or any combination of suitable clauses, wherein the 1-MCP is present in the powder at about 2.6%.

181. The solid composition of clause 157, any other suitable clause, or any combination of suitable clauses, wherein the 1-MCP is present in the powder at about 2.7%.

182. The solid composition of clause 157, any other suitable clause, or any combination of suitable clauses, wherein the 1-MCP is present in the powder at about 2.8%.

183. The solid composition of clause 157, any other suitable clause, or any combination of suitable clauses, wherein the 1-MCP is present in the powder at about 2.9%.

184. The solid composition of clause 157, any other suitable clause, or any combination of suitable clauses, wherein the 1-MCP is present in the powder at about 3%.

185. The solid composition of clause 157, any other suitable clause, or any combination of suitable clauses, wherein the 1-MCP is present in the powder at about 3.1%.

186. The solid composition of clause 157, any other suitable clause, or any combination of suitable clauses, wherein the 1-MCP is present in the powder at about 3.2%.

187. The solid composition of clause 157, any other suitable clause, or any combination of suitable clauses, wherein the 1-MCP is present in the powder at about 3.3%.

188. The solid composition of clause 157, any other suitable clause, or any combination of suitable clauses, wherein the 1-MCP is present in the powder at about 3.4%.

189. The solid composition of clause 157, any other suitable clause, or any combination of suitable clauses, wherein the 1-MCP is present in the powder at about 3.5%.

190. The solid composition of clause 157, any other suitable clause, or any combination of suitable clauses, wherein the 1-MCP is present in the powder at about 3.6%.

191. The solid composition of clause 157, any other suitable clause, or any combination of suitable clauses, wherein the 1-MCP is present in the powder at about 3.7%.

192. The solid composition of clause 157, any other suitable clause, or any combination of suitable clauses, wherein the 1-MCP is present in the powder at about 3.8%.

193. The solid composition of clause 157, any other suitable clause, or any combination of suitable clauses, wherein the 1-MCP is present in the powder at about 3.9%.

194. The solid composition of clause 157, any other suitable clause, or any combination of suitable clauses, wherein the 1-MCP is present in the powder at about 4%.

195. The solid composition of clause 157, any other suitable clause, or any combination of suitable clauses, wherein the 1-MCP is present in the powder at about 4.1%.

196. The solid composition of clause 157, any other suitable clause, or any combination of suitable clauses, wherein the 1-MCP is present in the powder at about 4.2%.

197. The solid composition of clause 157, any other suitable clause, or any combination of suitable clauses, wherein the 1-MCP is present in the powder at about 4.3%.

198. The solid composition of clause 157, any other suitable clause, or any combination of suitable clauses, wherein the 1-MCP is present in the powder at about 4.4%.

199. The solid composition of clause 157, any other suitable clause, or any combination of suitable clauses, wherein the 1-MCP is present in the powder at about 4.5%.

200. The solid composition of clause 157, any other suitable clause, or any combination of suitable clauses, wherein the 1-MCP is present in the powder at about 4.6%.

201. The solid composition of clause 157, any other suitable clause, or any combination of suitable clauses, wherein the 1-MCP is present in the powder at about 4.7%.

202. The solid composition of clause 157, any other suitable clause, or any combination of suitable clauses, wherein the 1-MCP is present in the powder at about 4.8%.

203. The solid composition of clause 157, any other suitable clause, or any combination of suitable clauses, wherein the 1-MCP is present in the powder at about 4.9%.

204. The solid composition of clause 157, any other suitable clause, or any combination of suitable clauses, wherein the 1-MCP is present in the powder at about 5%.

205. The solid composition of clause 145, any other suitable clause, or any combination of suitable clauses, wherein the gas-sequestering agent is selected from the group consisting of alpha cyclodextrin, activated charcoal, activated carbon, porous silica, molecular sieve, and any combination thereof.

206. The solid composition of clause 145, any other suitable clause, or any combination of suitable clauses, wherein the gas-sequestering agent comprises alpha cyclodextrin.

207. The solid composition of clause 145, any other suitable clause, or any combination of suitable clauses, wherein the gas-sequestering agent comprises activated charcoal.

208. The solid composition of clause 145, any other suitable clause, or any combination of suitable clauses, wherein the gas-sequestering agent comprises activated carbon.

209. The solid composition of clause 145, any other suitable clause, or any combination of suitable clauses, wherein the gas-sequestering agent comprises porous silica.

210. The solid composition of clause 145, any other suitable clause, or any combination of suitable clauses, wherein the gas-sequestering agent comprises a molecular sieve.

211. The solid composition of clause 145, any other suitable clause, or any combination of suitable clauses, wherein the gas-sequestering agent is from about 10% to about 98% by weight of the total composition.

212. The solid composition of clause 145, any other suitable clause, or any combination of suitable clauses, wherein the aqueous composition further comprises a water conditioning agent, a metal chelating agent, a pH controlling agent, a biocide, a preservative, a surfactant, a dispersant, a wetting agent, a spray adjuvant, a polymer, or any combination thereof.

213. The solid composition of clause 145, any other suitable clause, or any combination of suitable clauses, wherein the aqueous composition further comprises a fungicide, an insecticide, a herbicide, a fertilizer, a nutrient, or any combination thereof.

214. The solid composition of clause 145, any other suitable clause, or any combination of suitable clauses, wherein the solid composition is capable of dilution in water to form an aqueous composition.

215. A method of preparing an aqueous composition comprising the steps of
a) adding water into a vessel,
b) adding a gas-sequestering agent into the vessel,
c) adding 1-MCP into the vessel, and
d) mixing the water, the gas-sequestering agent, and the 1-MCP to form the aqueous composition.

216. The method of clause 215, any other suitable clause, or any combination of suitable clauses, wherein step c) is performed concurrently with step b).

217. The method of clause 215, any other suitable clause, or any combination of suitable clauses, wherein step c) is performed after step b).

218. The method of clause 215, any other suitable clause, or any combination of suitable clauses, wherein the mixing is performed until the aqueous composition is homogenous.

219. The method of clause 215, any other suitable clause, or any combination of suitable clauses, wherein the 1-MCP is comprised in a complex.

220. The method of clause 219, any other suitable clause, or any combination of suitable clauses, wherein the complex is an inclusion complex.

221. The method of clause 220, any other suitable clause, or any combination of suitable clauses, wherein the inclusion complex comprises cyclodextrin.

222. The method of clause 220, any other suitable clause, or any combination of suitable clauses, wherein the inclusion complex comprises alpha-cyclodextrin.

223. The method of clause 220, any other suitable clause, or any combination of suitable clauses, wherein the inclusion complex consists essentially of alpha-cyclodextrin.

224. The method of clause 220, any other suitable clause, or any combination of suitable clauses, wherein the inclusion complex consists of alpha-cyclodextrin.

225. The method of clause 220, any other suitable clause, or any combination of suitable clauses, wherein the gas-sequestering agent is derived from the inclusion complex.

226. The method of clause 219, any other suitable clause, or any combination of suitable clauses, wherein the complex is suspended as solid particles in the aqueous composition.

227. The method of clause 226, any other suitable clause, or any combination of suitable clauses, wherein the solid particle size is of an average between about 0.5 μm to about 30 μm.

228. The method of clause 219, any other suitable clause, or any combination of suitable clauses, wherein the complex is air milled.

229. The method of clause 219, any other suitable clause, or any combination of suitable clauses, wherein the complex is solubilized in the aqueous composition.

230. The method of clause 219, any other suitable clause, or any combination of suitable clauses, wherein the complex is present at a concentration from about 0.1% to about 50% by weight of the aqueous composition.

231. The method of clause 219, any other suitable clause, or any combination of suitable clauses, wherein the complex is present at a concentration from about 0.5% to about 30% by weight of the aqueous composition.

232. The method of clause 219, any other suitable clause, or any combination of suitable clauses, wherein the complex is present at a concentration from about 0.5% to about 20% by weight of the aqueous composition.

233. The method of clause 219, any other suitable clause, or any combination of suitable clauses, wherein the complex is present at a concentration from about 0.5% to about 10% by weight of the aqueous composition.

234. The method of clause 215, any other suitable clause, or any combination of suitable clauses, wherein the 1-MCP is comprised in a solution.

235. The method of clause 234, any other suitable clause, or any combination of suitable clauses, wherein the 1-MCP is present in the solution at about 0.1% to about 1.0%.

236. The method of clause 234, any other suitable clause, or any combination of suitable clauses, wherein the 1-MCP is present in the solution at about 1% to about 2%.

237. The method of clause 234, any other suitable clause, or any combination of suitable clauses, wherein the 1-MCP is present in the solution at about 2% to about 3%.

238. The method of clause 234, any other suitable clause, or any combination of suitable clauses, wherein the 1-MCP is present in the solution at about 3% to about 4%.

239. The method of clause 234, any other suitable clause, or any combination of suitable clauses, wherein the 1-MCP is present in the solution at about 4% to about 5%.

240 The method of clause 234, any other suitable clause, or any combination of suitable clauses, wherein the 1-MCP is present in the solution at about 1%.

241. The method of clause 234, any other suitable clause, or any combination of suitable clauses, wherein the 1-MCP is present in the solution at about 1.1%.

242. The method of clause 234, any other suitable clause, or any combination of suitable clauses, wherein the 1-MCP is present in the solution at about 1.2%.

243. The method of clause 234, any other suitable clause, or any combination of suitable clauses, wherein the 1-MCP is present in the solution at about 1.3%.

244. The method of clause 234, any other suitable clause, or any combination of suitable clauses, wherein the 1-MCP is present in the solution at about 1.4%.

245. The method of clause 234, any other suitable clause, or any combination of suitable clauses, wherein the 1-MCP is present in the solution at about 1.5%.

246. The method of clause 234, any other suitable clause, or any combination of suitable clauses, wherein the 1-MCP is present in the solution at about 1.6%.

247. The method of clause 234, any other suitable clause, or any combination of suitable clauses, wherein the 1-MCP is present in the solution at about 1.7%.

248. The method of clause 234, any other suitable clause, or any combination of suitable clauses, wherein the 1-MCP is present in the solution at about 1.8%.

249. The method of clause 234, any other suitable clause, or any combination of suitable clauses, wherein the 1-MCP is present in the solution at about 1.9%.

250. The method of clause 234, any other suitable clause, or any combination of suitable clauses, wherein the 1-MCP is present in the solution at about 2%.

251. The method of clause 234, any other suitable clause, or any combination of suitable clauses, wherein the 1-MCP is present in the solution at about 2.1%.

252. The method of clause 234, any other suitable clause, or any combination of suitable clauses, wherein the 1-MCP is present in the solution at about 2.2%.

253. The method of clause 234, any other suitable clause, or any combination of suitable clauses, wherein the 1-MCP is present in the solution at about 2.3%.

254. The method of clause 234, any other suitable clause, or any combination of suitable clauses, wherein the 1-MCP is present in the solution at about 2.4%.

255. The method of clause 234, any other suitable clause, or any combination of suitable clauses, wherein the 1-MCP is present in the solution at about 2.5%.

256. The method of clause 234, any other suitable clause, or any combination of suitable clauses, wherein the 1-MCP is present in the solution at about 2.6%.

257. The method of clause 234, any other suitable clause, or any combination of suitable clauses, wherein the 1-MCP is present in the solution at about 2.7%.

258. The method of clause 234, any other suitable clause, or any combination of suitable clauses, wherein the 1-MCP is present in the solution at about 2.8%.

259. The method of clause 234, any other suitable clause, or any combination of suitable clauses, wherein the 1-MCP is present in the solution at about 2.9%.

260. The method of clause 234, any other suitable clause, or any combination of suitable clauses, wherein the 1-MCP is present in the solution at about 3%.

261. The method of clause 234, any other suitable clause, or any combination of suitable clauses, wherein the 1-MCP is present in the solution at about 3.1%.

262. The method of clause 234, any other suitable clause, or any combination of suitable clauses, wherein the 1-MCP is present in the solution at about 3.2%.

263. The method of clause 234, any other suitable clause, or any combination of suitable clauses, wherein the 1-MCP is present in the solution at about 3.3%.

264. The method of clause 234, any other suitable clause, or any combination of suitable clauses, wherein the 1-MCP is present in the solution at about 3.4%.

265. The method of clause 234, any other suitable clause, or any combination of suitable clauses, wherein the 1-MCP is present in the solution at about 3.5%.

266. The method of clause 234, any other suitable clause, or any combination of suitable clauses, wherein the 1-MCP is present in the solution at about 3.6%.

267. The method of clause 234, any other suitable clause, or any combination of suitable clauses, wherein the 1-MCP is present in the solution at about 3.7%.

268. The method of clause 234, any other suitable clause, or any combination of suitable clauses, wherein the 1-MCP is present in the solution at about 3.8%.

269. The method of clause 234, any other suitable clause, or any combination of suitable clauses, wherein the 1-MCP is present in the solution at about 3.9%.

270. The method of clause 234, any other suitable clause, or any combination of suitable clauses, wherein the 1-MCP is present in the solution at about 4%.

271. The method of clause 234, any other suitable clause, or any combination of suitable clauses, wherein the 1-MCP is present in the solution at about 4.1%.

272. The method of clause 234, any other suitable clause, or any combination of suitable clauses, wherein the 1-MCP is present in the solution at about 4.2%.

273. The method of clause 234, any other suitable clause, or any combination of suitable clauses, wherein the 1-MCP is present in the solution at about 4.3%.

274 The method of clause 234, any other suitable clause, or any combination of suitable clauses, wherein the 1-MCP is present in the solution at about 4.4%.

275. The method of clause 234, any other suitable clause, or any combination of suitable clauses, wherein the 1-MCP is present in the solution at about 4.5%.

276. The method of clause 234, any other suitable clause, or any combination of suitable clauses, wherein the 1-MCP is present in the solution at about 4.6%.

277. The method of clause 234, any other suitable clause, or any combination of suitable clauses, wherein the 1-MCP is present in the solution at about 4.7%.

278. The method of clause 234, any other suitable clause, or any combination of suitable clauses, wherein the 1-MCP is present in the solution at about 4.8%.

279. The method of clause 234, any other suitable clause, or any combination of suitable clauses, wherein the 1-MCP is present in the solution at about 4.9%.

280. The method of clause 234, any other suitable clause, or any combination of suitable clauses, wherein the 1-MCP is present in the solution at about 5%.

281. The method of clause 215, any other suitable clause, or any combination of suitable clauses, wherein the 1-MCP is comprised in a powder.

282. The method of clause 281, any other suitable clause, or any combination of suitable clauses, wherein the powder is a wettable powder.

283. The method of clause 281, any other suitable clause, or any combination of suitable clauses, wherein the 1-MCP is present in the powder at about 0.1% to about 1.0%.

284. The method of clause 281, any other suitable clause, or any combination of suitable clauses, wherein the 1-MCP is present in the powder at about 1% to about 2%.

285. The method of clause 281, any other suitable clause, or any combination of suitable clauses, wherein the 1-MCP is present in the powder at about 2% to about 3%.

286. The method of clause 281, any other suitable clause, or any combination of suitable clauses, wherein the 1-MCP is present in the powder at about 3% to about 4%.

287. The method of clause 281, any other suitable clause, or any combination of suitable clauses, wherein the 1-MCP is present in the powder at about 4% to about 5%.

288. The method of clause 281, any other suitable clause, or any combination of suitable clauses, wherein the 1-MCP is present in the powder at about 1%.

289. The method of clause 281, any other suitable clause, or any combination of suitable clauses, wherein the 1-MCP is present in the powder at about 1.1%.

290. The method of clause 281, any other suitable clause, or any combination of suitable clauses, wherein the 1-MCP is present in the powder at about 1.2%.

291. The method of clause 281, any other suitable clause, or any combination of suitable clauses, wherein the 1-MCP is present in the powder at about 1.3%.

292. The method of clause 281, any other suitable clause, or any combination of suitable clauses, wherein the 1-MCP is present in the powder at about 1.4%.

293. The method of clause 281, any other suitable clause, or any combination of suitable clauses, wherein the 1-MCP is present in the powder at about 1.5%.

294. The method of clause 281, any other suitable clause, or any combination of suitable clauses, wherein the 1-MCP is present in the powder at about 1.6%.

295. The method of clause 281, any other suitable clause, or any combination of suitable clauses, wherein the 1-MCP is present in the powder at about 1.7%.

296. The method of clause 281, any other suitable clause, or any combination of suitable clauses, wherein the 1-MCP is present in the powder at about 1.8%.

297. The method of clause 281, any other suitable clause, or any combination of suitable clauses, wherein the 1-MCP is present in the powder at about 1.9%.

298. The method of clause 281, any other suitable clause, or any combination of suitable clauses, wherein the 1-MCP is present in the powder at about 2%.

299. The method of clause 281, any other suitable clause, or any combination of suitable clauses, wherein the 1-MCP is present in the powder at about 2.1%.

300. The method of clause 281, any other suitable clause, or any combination of suitable clauses, wherein the 1-MCP is present in the powder at about 2.2%.

301. The method of clause 281, any other suitable clause, or any combination of suitable clauses, wherein the 1-MCP is present in the powder at about 2.3%.

302. The method of clause 281, any other suitable clause, or any combination of suitable clauses, wherein the 1-MCP is present in the powder at about 2.4%.

303. The method of clause 281, any other suitable clause, or any combination of suitable clauses, wherein the 1-MCP is present in the powder at about 2.5%.

304. The method of clause 281, any other suitable clause, or any combination of suitable clauses, wherein the 1-MCP is present in the powder at about 2.6%.

305. The method of clause 281, any other suitable clause, or any combination of suitable clauses, wherein the 1-MCP is present in the powder at about 2.7%.

306. The method of clause 281, any other suitable clause, or any combination of suitable clauses, wherein the 1-MCP is present in the powder at about 2.8%.

307. The method of clause 281, any other suitable clause, or any combination of suitable clauses, wherein the 1-MCP is present in the powder at about 2.9%.

308. The method of clause 281, any other suitable clause, or any combination of suitable clauses, wherein the 1-MCP is present in the powder at about 3%.

309 The method of clause 281, any other suitable clause, or any combination of suitable clauses, wherein the 1-MCP is present in the powder at about 3.1%.

310. The method of clause 281, any other suitable clause, or any combination of suitable clauses, wherein the 1-MCP is present in the powder at about 3.2%.

311. The method of clause 281, any other suitable clause, or any combination of suitable clauses, wherein the 1-MCP is present in the powder at about 3.3%.

312. The method of clause 281, any other suitable clause, or any combination of suitable clauses, wherein the 1-MCP is present in the powder at about 3.4%.

313. The method of clause 281, any other suitable clause, or any combination of suitable clauses, wherein the 1-MCP is present in the powder at about 3.5%.

314. The method of clause 281, any other suitable clause, or any combination of suitable clauses, wherein the 1-MCP is present in the powder at about 3.6%.

315. The method of clause 281, any other suitable clause, or any combination of suitable clauses, wherein the 1-MCP is present in the powder at about 3.7%.

316. The method of clause 281, any other suitable clause, or any combination of suitable clauses, wherein the 1-MCP is present in the powder at about 3.8%.

317. The method of clause 281, any other suitable clause, or any combination of suitable clauses, wherein the 1-MCP is present in the powder at about 3.9%.

318. The method of clause 281, any other suitable clause, or any combination of suitable clauses, wherein the 1-MCP is present in the powder at about 4%.

319. The method of clause 281, any other suitable clause, or any combination of suitable clauses, wherein the 1-MCP is present in the powder at about 4.1%.

320. The method of clause 281, any other suitable clause, or any combination of suitable clauses, wherein the 1-MCP is present in the powder at about 4.2%.

321. The method of clause 281, any other suitable clause, or any combination of suitable clauses, wherein the 1-MCP is present in the powder at about 4.3%.

322. The method of clause 281, any other suitable clause, or any combination of suitable clauses, wherein the 1-MCP is present in the powder at about 4.4%.

323. The method of clause 281, any other suitable clause, or any combination of suitable clauses, wherein the 1-MCP is present in the powder at about 4.5%.

324. The method of clause 281, any other suitable clause, or any combination of suitable clauses, wherein the 1-MCP is present in the powder at about 4.6%.

325. The method of clause 281, any other suitable clause, or any combination of suitable clauses, wherein the 1-MCP is present in the powder at about 4.7%.

326. The method of clause 281, any other suitable clause, or any combination of suitable clauses, wherein the 1-MCP is present in the powder at about 4.8%.

327. The method of clause 281, any other suitable clause, or any combination of suitable clauses, wherein the 1-MCP is present in the powder at about 4.9%.

328. The method of clause 281, any other suitable clause, or any combination of suitable clauses, wherein the 1-MCP is present in the powder at about 5%.

329. The method of clause 215, any other suitable clause, or any combination of suitable clauses, wherein the gas-sequestering agent is selected from the group consisting of alpha cyclodextrin, activated charcoal, activated carbon, porous silica, molecular sieve, and any combination thereof.

330. The method of clause 215, any other suitable clause, or any combination of suitable clauses, wherein the gas-sequestering agent comprises alpha cyclodextrin.

331. The method of clause 215, any other suitable clause, or any combination of suitable clauses, wherein the gas-sequestering agent comprises activated charcoal.

332. The method of clause 215, any other suitable clause, or any combination of suitable clauses, wherein the gas-sequestering agent comprises activated carbon.

333. The method of clause 215, any other suitable clause, or any combination of suitable clauses, wherein the gas-sequestering agent comprises porous silica.

334. The method of clause 215, any other suitable clause, or any combination of suitable clauses, wherein the gas-sequestering agent comprises a molecular sieve.

335. The method of clause 215, any other suitable clause, or any combination of suitable clauses, wherein the gas-sequestering agent is from about 0.1% to about 50% by weight of the water in the aqueous composition.

336. The method of clause 215, any other suitable clause, or any combination of suitable clauses, wherein the gas-sequestering agent is from about 1% to about 30% by weight of the water in the aqueous composition.

337. The method of clause 215, any other suitable clause, or any combination of suitable clauses, wherein the gas-sequestering agent is from about 2% to about 20% by weight of the water in the aqueous composition.

338. The method of clause 215, any other suitable clause, or any combination of suitable clauses, wherein the gas-sequestering agent is from about 2.5% to about 15% by weight of the water in the aqueous composition.

339. The method of clause 215, any other suitable clause, or any combination of suitable clauses, wherein the gas-sequestering agent is from about 1% to about 10% by weight of the water in the aqueous composition.

340. The method of clause 215, any other suitable clause, or any combination of suitable clauses, wherein the gas-sequestering agent is from about 3% to about 10% by weight of the water in the aqueous composition.

341. The method of clause 215, any other suitable clause, or any combination of suitable clauses, wherein the gas-sequestering agent is about 1% by weight of the water in the aqueous composition.

342. The method of clause 215, any other suitable clause, or any combination of suitable clauses, wherein the gas-sequestering agent is about 2% by weight of the water in the aqueous composition.

343. The method of clause 215, any other suitable clause, or any combination of suitable clauses, wherein the gas-sequestering agent is about 3% by weight of the water in the aqueous composition.

344 The method of clause 215, any other suitable clause, or any combination of suitable clauses, wherein the gas-sequestering agent is about 4% by weight of the water in the aqueous composition.

345. The method of clause 215, any other suitable clause, or any combination of suitable clauses, wherein the gas-sequestering agent is about 5% by weight of the water in the aqueous composition.

346. The method of clause 215, any other suitable clause, or any combination of suitable clauses, wherein the gas-sequestering agent is about 6% by weight of the water in the aqueous composition.

347. The method of clause 215, any other suitable clause, or any combination of suitable clauses, wherein the gas-sequestering agent is about 7% by weight of the water in the aqueous composition.

348. The method of clause 215, any other suitable clause, or any combination of suitable clauses, wherein the gas-sequestering agent is about 8% by weight of the water in the aqueous composition.

349. The method of clause 215, any other suitable clause, or any combination of suitable clauses, wherein the gas-sequestering agent is about 9% by weight of the water in the aqueous composition.

350. The method of clause 215, any other suitable clause, or any combination of suitable clauses, wherein the gas-sequestering agent is about 10% by weight of the water in the aqueous composition.

351. The method of clause 215, any other suitable clause, or any combination of suitable clauses, wherein the gas-sequestering agent is about 11% by weight of the water in the aqueous composition.

352. The method of clause 215, any other suitable clause, or any combination of suitable clauses, wherein the gas-sequestering agent is about 12% by weight of the water in the aqueous composition.

353. The method of clause 215, any other suitable clause, or any combination of suitable clauses, wherein the gas-sequestering agent is about 13% by weight of the water in the aqueous composition.

354. The method of clause 215, any other suitable clause, or any combination of suitable clauses, wherein the gas-sequestering agent is about 14% by weight of the water in the aqueous composition.

355. The method of clause 215, any other suitable clause, or any combination of suitable clauses, wherein the gas-sequestering agent is about 15% by weight of the water in the aqueous composition.

356, wherein the aqueous composition further comprises a water conditioning agent, a The method of clause 215, any other suitable clause, or any combination of suitable clauses, metal chelating agent, a pH controlling agent, a biocide, a preservative, a surfactant, a dispersant, a wetting agent, a spray adjuvant, a polymer, or any combination thereof.

357. The method of clause 215, any other suitable clause, or any combination of suitable clauses, wherein the aqueous composition further comprises a fungicide, an insecticide, a herbicide, a fertilizer, a nutrient, or any combination thereof.

358. A method of preparing solid composition comprising the steps of
a) adding a gas-sequestering agent into a vessel,
b) adding 1-MCP into the vessel, and
c) blending the gas-sequestering agent and the 1-MCP to form the sold composition.

359. The method of clause 358, any other suitable clause, or any combination of suitable clauses, wherein the blending is performed until the solid composition is homogenous.

360. The method of clause 358, any other suitable clause, or any combination of suitable clauses, wherein the 1-MCP is comprised in a complex.

361. The method of clause 360, any other suitable clause, or any combination of suitable clauses, wherein the complex is an inclusion complex.

362. The method of clause 361, any other suitable clause, or any combination of suitable clauses, wherein the inclusion complex comprises cyclodextrin.

363. The method of clause 361, any other suitable clause, or any combination of suitable clauses, wherein the inclusion complex comprises alpha-cyclodextrin.

364. The method of clause 361, any other suitable clause, or any combination of suitable clauses, wherein the inclusion complex consists essentially of alpha-cyclodextrin.

365 The method of clause 361, any other suitable clause, or any combination of suitable clauses, wherein the inclusion complex consists of alpha-cyclodextrin.

366. The method of clause 361, any other suitable clause, or any combination of suitable clauses, wherein the gas-sequestering agent is derived from the inclusion complex.

367. The method of clause 360, any other suitable clause, or any combination of suitable clauses, wherein the complex is present as solid particles in the solid composition.

368. The method of clause 367, any other suitable clause, or any combination of suitable clauses, wherein the solid particle size is of an average between about 0.5 μm to about 30 μm.

369. The method of clause 360, any other suitable clause, or any combination of suitable clauses, wherein the complex is air milled.

370. The method of clause 360, any other suitable clause, or any combination of suitable clauses, wherein the complex is from about 2% to about 90% by weight of the total composition.

371. The method of clause 358, any other suitable clause, or any combination of suitable clauses, wherein the 1-MCP is comprised in a powder.

372. The method of clause 371, any other suitable clause, or any combination of suitable clauses, wherein the powder is a wettable powder.

373. The method of clause 371, any other suitable clause, or any combination of suitable clauses, wherein the 1-MCP is present in the powder at about 0.1% to about 1.0%.

374. The method of clause 371, any other suitable clause, or any combination of suitable clauses, wherein the 1-MCP is present in the powder at about 1% to about 2%.

375. The method of clause 371, any other suitable clause, or any combination of suitable clauses, wherein the 1-MCP is present in the powder at about 2% to about 3%.

376. The method of clause 371, any other suitable clause, or any combination of suitable clauses, wherein the 1-MCP is present in the powder at about 3% to about 4%.

377. The method of clause 371, any other suitable clause, or any combination of suitable clauses, wherein the 1-MCP is present in the powder at about 4% to about 5%.

378. The method of clause 371, any other suitable clause, or any combination of suitable clauses, wherein the 1-MCP is present in the powder at about 1%.

379. The method of clause 371, any other suitable clause, or any combination of suitable clauses, wherein the 1-MCP is present in the powder at about 1.1%.

380. The method of clause 371, any other suitable clause, or any combination of suitable clauses, wherein the 1-MCP is present in the powder at about 1.2%.

381. The method of clause 371, any other suitable clause, or any combination of suitable clauses, wherein the 1-MCP is present in the powder at about 1.3%.

382. The method of clause 371, any other suitable clause, or any combination of suitable clauses, wherein the 1-MCP is present in the powder at about 1.4%.

383. The method of clause 371, any other suitable clause, or any combination of suitable clauses, wherein the 1-MCP is present in the powder at about 1.5%.

384. The method of clause 371, any other suitable clause, or any combination of suitable clauses, wherein the 1-MCP is present in the powder at about 1.6%.

385. The method of clause 371, any other suitable clause, or any combination of suitable clauses, wherein the 1-MCP is present in the powder at about 1.7%.

386. The method of clause 371, any other suitable clause, or any combination of suitable clauses, wherein the 1-MCP is present in the powder at about 1.8%.

387. The method of clause 371, any other suitable clause, or any combination of suitable clauses, wherein the 1-MCP is present in the powder at about 1.9%.

388. The method of clause 371, any other suitable clause, or any combination of suitable clauses, wherein the 1-MCP is present in the powder at about 2%.

389. The method of clause 371, any other suitable clause, or any combination of suitable clauses, wherein the 1-MCP is present in the powder at about 2.1%.

390. The method of clause 371, any other suitable clause, or any combination of suitable clauses, wherein the 1-MCP is present in the powder at about 2.2%.

391. The method of clause 371, any other suitable clause, or any combination of suitable clauses, wherein the 1-MCP is present in the powder at about 2.3%.

392. The method of clause 371, any other suitable clause, or any combination of suitable clauses, wherein the 1-MCP is present in the powder at about 2.4%.

393. The method of clause 371, any other suitable clause, or any combination of suitable clauses, wherein the 1-MCP is present in the powder at about 2.5%.

394. The method of clause 371, any other suitable clause, or any combination of suitable clauses, wherein the 1-MCP is present in the powder at about 2.6%.

395. The method of clause 371, any other suitable clause, or any combination of suitable clauses, wherein the 1-MCP is present in the powder at about 2.7%.

396. The method of clause 371, any other suitable clause, or any combination of suitable clauses, wherein the 1-MCP is present in the powder at about 2.8%.

397. The method of clause 371, any other suitable clause, or any combination of suitable clauses, wherein the 1-MCP is present in the powder at about 2.9%.

398. The method of clause 371, any other suitable clause, or any combination of suitable clauses, wherein the 1-MCP is present in the powder at about 3%.

399. The method of clause 371, any other suitable clause, or any combination of suitable clauses, wherein the 1-MCP is present in the powder at about 3.1%.

400. The method of clause 371, any other suitable clause, or any combination of suitable clauses, wherein the 1-MCP is present in the powder at about 3.2%.

401. The method of clause 371, any other suitable clause, or any combination of suitable clauses, wherein the 1-MCP is present in the powder at about 3.3%.

402. The method of clause 371, any other suitable clause, or any combination of suitable clauses, wherein the 1-MCP is present in the powder at about 3.4%.

403. The method of clause 371, any other suitable clause, or any combination of suitable clauses, wherein the 1-MCP is present in the powder at about 3.5%.

404. The method of clause 371, any other suitable clause, or any combination of suitable clauses, wherein the 1-MCP is present in the powder at about 3.6%.

405. The method of clause 371, any other suitable clause, or any combination of suitable clauses, wherein the 1-MCP is present in the powder at about 3.7%.

406. The method of clause 371, any other suitable clause, or any combination of suitable clauses, wherein the 1-MCP is present in the powder at about 3.8%.

407. The method of clause 371, any other suitable clause, or any combination of suitable clauses, wherein the 1-MCP is present in the powder at about 3.9%.

408. The method of clause 371, any other suitable clause, or any combination of suitable clauses, wherein the 1-MCP is present in the powder at about 4%.

409. The method of clause 371, any other suitable clause, or any combination of suitable clauses, wherein the 1-MCP is present in the powder at about 4.1%.

410. The method of clause 371, any other suitable clause, or any combination of suitable clauses, wherein the 1-MCP is present in the powder at about 4.2%.

411. The method of clause 371, any other suitable clause, or any combination of suitable clauses, wherein the 1-MCP is present in the powder at about 4.3%.

412. The method of clause 371, any other suitable clause, or any combination of suitable clauses, wherein the 1-MCP is present in the powder at about 4.4%.

413. The method of clause 371, any other suitable clause, or any combination of suitable clauses, wherein the 1-MCP is present in the powder at about 4.5%.

414. The method of clause 371, any other suitable clause, or any combination of suitable clauses, wherein the 1-MCP is present in the powder at about 4.6%.

415. The method of clause 371, any other suitable clause, or any combination of suitable clauses, wherein the 1-MCP is present in the powder at about 4.7%.

416. The method of clause 371, any other suitable clause, or any combination of suitable clauses, wherein the 1-MCP is present in the powder at about 4.8%.

417. The method of clause 371, any other suitable clause, or any combination of suitable clauses, wherein the 1-MCP is present in the powder at about 4.9%.

418. The method of clause 371, any other suitable clause, or any combination of suitable clauses, wherein the 1-MCP is present in the powder at about 5%.

419. The method of clause 358, any other suitable clause, or any combination of suitable clauses, wherein the gas-sequestering agent is selected from the group consisting of alpha cyclodextrin, activated charcoal, activated carbon, porous silica, molecular sieve, and any combination thereof.

420. The method of clause 358, any other suitable clause, or any combination of suitable clauses, wherein the gas-sequestering agent comprises alpha cyclodextrin.

421. The method of clause 358, any other suitable clause, or any combination of suitable clauses, wherein the gas-sequestering agent comprises activated charcoal.

422. The method of clause 358, any other suitable clause, or any combination of suitable clauses, wherein the gas-sequestering agent comprises activated carbon.

423. The method of clause 358, any other suitable clause, or any combination of suitable clauses, wherein the gas-sequestering agent comprises porous silica.

424. The method of clause 358, any other suitable clause, or any combination of suitable clauses, wherein the gas-sequestering agent comprises a molecular sieve.

425. The method of clause 358, any other suitable clause, or any combination of suitable clauses, wherein the gas-sequestering agent is from about 10% to about 98% by weight of the total composition.

426. The method of clause 358, any other suitable clause, or any combination of suitable clauses, wherein the solid composition further comprises a water conditioning agent, a metal chelating agent, a pH controlling agent, a biocide, a preservative, a surfactant, a dispersant, a wetting agent, a spray adjuvant, a polymer, or any combination thereof.

427. The method of clause 358, any other suitable clause, or any combination of suitable clauses, wherein the solid composition further comprises a fungicide, an insecticide, a herbicide, a fertilizer, a nutrient, or any combination thereof.

428. The method of clause 358, any other suitable clause, or any combination of suitable clauses, wherein the solid composition is a granule blend.

429. The method of clause 358, any other suitable clause, or any combination of suitable clauses, wherein the solid composition is a powder blend.

430. The method of clause 429, any other suitable clause, or any combination of suitable clauses, wherein the powder blend is capable of granulation.

431. A method of applying an aqueous composition to a plant or plant part, said method comprising the step of administering the aqueous composition to the plant or plant part via farm equipment.

432. The method of clause 431, any other suitable clause, or any combination of suitable clauses, wherein the farm equipment comprises ground spray equipment.

433. The method of clause 431, any other suitable clause, or any combination of suitable clauses, wherein the farm equipment comprises aerial spray equipment.

434 The method of clause 431, any other suitable clause, or any combination of suitable clauses, wherein the farm equipment comprises drone spray equipment.

435. The method of clause 431, any other suitable clause, or any combination of suitable clauses, wherein the farm equipment comprises backpack spray equipment.

436. The method of clause 431, any other suitable clause, or any combination of suitable clauses, wherein the farm equipment comprises a spray tank or vessel.

437. The method of clause 436, any other suitable clause, or any combination of suitable clauses, wherein the spray tank or vessel is vented.

438. The method of clause 431, any other suitable clause, or any combination of suitable clauses, wherein the aqueous composition is prepared in-situ.

439. The method of clause 431, any other suitable clause, or any combination of suitable clauses, wherein the aqueous composition is the aqueous composition of any one of clauses 1 to 144.

440. The method of clause 431, any other suitable clause, or any combination of suitable clauses, wherein the aqueous composition is the prepared according to any one of clauses 215 to 357.

### EXAMPLES

### Example 1

### 1-MCP Analysis in Various Compositions

For the instant example, the following materials can be utilized: Harvista™ (AF-701), containing 1.21% 1-MCP; 1-MCP/alpha cyclodextrin complex (HAIP), containing 4.68% 1-MCP; 1-MCP/alpha cyclodextrin complex (AFxRD-038), containing 4.05% 1-MCP; and Air milled HAIP, containing 4.29% 1-MCP.

For the instant example, the following procedure was followed:
1. Prepared a-CD aqueous stock solutions of various concentrations by adding and dissolving appropriate amount of a-CD into water.
2. Weighed 1-MCP formulation (aka AF-701) into a ~122 ml serum bottle.
3. Weighed α-CD stock solutions into the bottle and then immediately sealed the bottle with a gas-sampling cap.
4. The bottles were placed on horizontal orbital shaker throughout the experiment, the headspace and liquid phase were analyzed for 1-MCP by GC-FID at various time points.

The following results were obtained for the instant example:

| | | 1.13148 g | 1.15293 g | 1.10777 g | 1.13339 g |
|---|---|---|---|---|---|
| | | AF-701 | AF-701 | AF-701 | AF-701 |
| | | 48.12 g | 49.00 g | 47.12 g | 48.21 g |
| | | 2.5% α- | 5% α- | 7.5% α- | 10% α- |
| | | CD (aq) | CD (aq) | CD (aq) | CD (aq) |
| 5 | Headspace 1- | 4776 | 3535 | 2683 | 2459 |
| mins | MCP concentra- | | | | |
| | tion (ppm by | | | | |
| | v/v) | | | | |
| | % 1-MCP | 82 | 85 | 89 | 87 |
| | retained | | | | |
| | in liquid | | | | |
| 160 | Headspace 1- | 9354 | 5595 | 4421 | 3163 |
| mins | MCP concentra- | | | | |
| | tion (ppm by | | | | |
| | v/v) | | | | |
| | % 1-MCP | 76 | 81 | 80 | 79 |
| | retained | | | | |
| | in liquid | | | | |
| 340 | Headspace 1- | 10649 | 6386 | 4463 | 3345 |
| mins | MCP concentra- | | | | |
| | tion (ppm by | | | | |
| | v/v) | | | | |
| | % 1-MCP | 65 | 77 | 74 | 80 |
| | retained | | | | |
| | in liquid | | | | |
| 1440 | Headspace 1- | 9541 | 3286 | 3049 | 2048 |
| mins | MCP concentra | | | | |
| | tion (ppm by | | | | |
| | v/v) | | | | |
| | % 1-MCP | 47 | 58 | 61 | 64 |
| | retained | | | | |
| | in liquid | | | | |

### Example 2

### 1-MCP Analysis in Various Compositions

For the instant example, the following materials can be utilized: Harvista™ (AF-701), containing 1.21% 1-MCP; 1-MCP/alpha cyclodextrin complex (HAIP), containing 4.68% 1-MCP; 1-MCP/alpha cyclodextrin complex (AFxRD-038), containing 4.05% 1-MCP; and Air milled HAIP, containing 4.29% 1-MCP.

For the instant example, the following procedure was followed:
1. Weigh 1-MCP formulation (aka AF-701) into a ~250 ml bottle.
2. Add appropriate amount of water into the bottle, and then immediately seal the bottle with a gas-sampling cap.
3. The bottles were placed on horizontal orbital shaker throughout the experiment, the headspace were analyzed for 1-MCP by GC-FID at various time points.

The following results were obtained for the instant example:

| | Spray volume | 25 L/ha | 50 L/ha | 100 L/ha |
|---|---|---|---|---|
| | Composition to | 36 ml | 18 ml | 9 ml |
| | provide ~60 | AF-701, | AF-701, | AF-701, |
| | g/ac 1-MCP | 64 ml | 82 ml | 91 ml |
| | use rate | water | water | water |
| 1-MCP | 10 mins | 22213 | 32082 | 40399 |
| concentration | 20 mins | 25113 | 37777 | 47070 |
| in headspace, | 60 mins | 26376 | 42671 | 54203 |
| ppm by v/v | | | | |

### Example 3

### 1-MCP Analysis in Various Compositions

For the instant example, the following materials can be utilized: Harvista™ (AF-701), containing 1.21% 1-MCP; 1-MCP/alpha cyclodextrin complex (HAIP), containing 4.68% 1-MCP; 1-MCP/alpha cyclodextrin complex (AFxRD-038), containing 4.05% 1-MCP; and Air milled HAIP, containing 4.29% 1-MCP.

For the instant example, the following procedure was followed:
1. Prepared 10% by wt of a-CD aqueous stock solutions by adding and dissolving appropriate amount of a-CD into water.
2. Weighed 1-MCP formulation (aka AF-701) into a ~122 ml serum bottle.
3. Weighed α-CD stock solutions into the bottle and then immediately sealed the bottle with a gas-sampling cap.
4. The bottles were placed on horizontal orbital shaker throughout the experiment, the headspace and liquid phase were analyzed for 1-MCP by GC-FID at various time points.

The following results were obtained for the instant example:

| | Spray volume, L/acre | | | | |
|---|---|---|---|---|---|
| | 30 L/ac | 50 L/ac | 100 L/ac | 200 L/ac | 400 L/ac |
| Composition to | 7.7 g AF-701 | 4.62 g AF-701 | 2.31 g AF-701 | 1.155 g AF-701 | .5775 g AF-701 |
| provide ~60 g/ac | 44.167 g 10% | 46.5 g 10% | 48.25 g 10% | 49.125 g 10% | 49.563 g 10% |
| 1-MCP use rate | α-CD (aq) | α-CD (aq) | α-CD (aq) | α-CD (aq) | α-CD (aq) |
| Headspace 1-MCP | 2386 | 2869 | 2497 | 2643 | 2491 |
| concentration | | | | | |
| (ppm by v/v) | | | | | |
| % 1-MCP retained | 91 | 88 | 81 | 74 | 60 |
| in liquid over 24 | | | | | |
| hours | | | | | |

### Example 4

### 1-MCP Analysis in Various Compositions

For the instant example, the following materials can be utilized: Harvista™ (AF-701), containing 1.21% 1-MCP; 1-MCP/alpha cyclodextrin complex (HAIP), containing 4.68% 1-MCP; 1-MCP/alpha cyclodextrin complex (AFxRD-038), containing 4.05% 1-MCP; and Air milled HAIP, containing 4.29% 1-MCP.

For the instant example, the following procedure was followed:
1. Prepared 10% by wt of a-CD aqueous stock solutions by adding and dissolving appropriate amount of a-CD into water.
2. Weighed 1-MCP formulation (aka AF-701) into a ~122 ml serum bottle.
3. Weighed α-CD stock solutions into the bottle and then immediately sealed the bottle with a gas-sampling cap.
4. The bottles were placed on horizontal orbital shaker throughout the experiment, the headspace and liquid phase were analyzed for 1-MCP by GC-FID at various time points.

The following results were obtained for the instant example, showing the % 1-MCP retention over time, with 10% α-CD (aq) at the 200 L/ac spray volume:

| Time elapsed, mins | 15 | 120 | 240 | 420 | 1440 | 2940 |
|---|---|---|---|---|---|---|
| % 1-MCP retained | 93 | 85 | 82 | 81 | 74 | 67 |
| in liquid | | | | | | |

### Example 5

### 1-MCP Analysis in Various Compositions

For the instant example, the following materials can be utilized: Harvista™ (AF-701), containing 1.21% 1-MCP; 1-MCP/alpha cyclodextrin complex (HAIP), containing 4.68% 1-MCP; 1-MCP/alpha cyclodextrin complex (AFxRD-038), containing 4.05% 1-MCP; and Air milled HAIP, containing 4.29% 1-MCP.

For the instant example, the following procedure was followed:
1. Weighed α-CD solid into a ~135 ml Wheaton bottle.
2. Weighed air milled HAIP into the bottle.
3. Weighed EDTA tetrasodium into the bottle.
4. Warmed water to 40 C then add appropriate amount into the bottle and then immediately sealed the bottle with a gas-sampling cap.
5. The bottles were placed on horizontal orbital shaker throughout the experiment, the headspace was analyzed for 1-MCP by GC-FID at various time points.

The following results were obtained for the instant example:

| | |
|---|---|
| 10% (6 g) | alpha-CD |
| 2.5% (1.5 g) | Air milled |
| 0/0.08% (50 mg) | EDTA |
| 87.5% (52.5 g) | water |

| | | | |
|---|---|---|---|
| Time elapsed at 40 C., mins | 10 | 60 | 240 |
| Average 1-MCP | 6214 | 7164 | 7920 |
| concentration in headspace, | | | |
| ppm by v/v | | | |

### Example 6

### 1-MCP Analysis in Various Compositions

For the instant example, the following materials can be utilized: Harvista™ (AF-701), containing 1.21% 1-MCP; 1-MCP/alpha cyclodextrin complex (HAIP), containing 4.68% 1-MCP; 1-MCP/alpha cyclodextrin complex (AFxRD-038), containing 4.05% 1-MCP; and Air milled HAIP, containing 4.29% 1-MCP.

For the instant example, the following procedure was followed:
1. Prepared aqueous stock solutions of candidate gas confining agents with various concentrations by adding appropriate amounts of materials into water.
2. Weighed solid HAIP into a ~122 ml serum bottle.
3. Weighed stock solutions into the bottle and then immediately sealed the bottle with a gas-sampling cap.
4. The bottles were placed on horizontal orbital shaker throughout the experiment, the headspace was analyzed for 1-MCP by GC-FID at various time points.

The following results were obtained for the instant example:

| | | | | |
|---|---|---|---|---|
| HAIP | 2.398 g | 4.912 g | 4.855 g | 4.820 |
| Candidate gas | 20.15 g | 19.515 g | 19.442 g | 18.718 g |
| confining agent | 5% charcoal | 10% charcoal | 5% Flo- | 10% Flo- |
| stock Solution | | | Gard silica | Gard silica |
| 1-MCP | 6450 | 2546 | 13310 | 13284 |
| concentration | | | | |
| in headspace at | | | | |
| 4 hours (ppm v/v) | | | | |

### Example 7

### 1-MCP Analysis in Various Compositions

For the instant example, the following materials can be utilized: Harvista™ (AF-701), containing 1.21% 1-MCP; 1-MCP/alpha cyclodextrin complex (HAIP), containing 4.68% 1-MCP; 1-MCP/alpha cyclodextrin complex (AFxRD-038), containing 4.05% 1-MCP; and Air milled HAIP, containing 4.29% 1-MCP.

For the instant example, the following procedure was followed:
1. Prepared an aqueous stock solution saturated with alpha cyclodextrin at 40 C by adding excessive amount of alpha cyclodextrin till solid sediments were visible.
2. Weighed air milled HAIP into a ~135 ml Wheaton bottle.
3. Added appropriate amount the stock solution at 40 C into the bottle and then immediately sealed the bottle with a gas-sampling cap.
4. The bottles were placed on horizontal orbital shaker throughout the experiment, the headspace was analyzed for 1-MCP by GC-FID at various time points.

The following results were obtained for the instant example:

| | 40 C. saturated | 1-MCP concentration in |
|---|---|---|
| Air milled HAIP | alpha cyclodextrin | headspace at 4 hours |
| (g) | solution (g) | (ppm v/v) |
| 2 | 58 | 7966 |
| 2.5 | 57.5 | 6589 |
| 2.5 | 57.5 | 5630 |
| 2.5 | 57.5 | 6005 |

### Example 8

### 1-MCP Analysis in Various Compositions

For the instant example, the following materials can be utilized: Harvista™ (AF-701), containing 1.21% 1-MCP; 1-MCP/alpha cyclodextrin complex (HAIP), containing 4.68% 1-MCP; 1-MCP/alpha cyclodextrin complex (AFxRD-038), containing 4.05% 1-MCP; and Air milled HAIP, containing 4.29% 1-MCP.

For the instant example, the following procedure was followed:
1. Weighed air milled HAIP into a ~135 ml Wheaton bottle.
2. Weighed alpha cyclodextrin into the bottle.
3. Added appropriate amount of 40 C water into the bottle and then immediately sealed the bottle with a gas-sampling cap.
4. The bottles were placed on horizontal orbital shaker throughout the experiment, the headspace was analyzed for 1-MCP by GC-FID at various time points.

The following results were obtained for the instant example:

| | Alpha | 40 C. | 1-MCP concentration |
|---|---|---|---|
| Air milled | cyclodextrin | water | in headspace at |
| HAIP (g) | (g) | (g) | 4 hours (ppm v/v) |
| 1.5 | 6 | 52.5 | 7863 |
| 2 | 4 | 54 | 7993 |
| 1.5 | 4 | 54.5 | 13849 |
| 1.5 | 5 | 53.5 | 7580 |
| 1.5 | 5 | 53.5 | 9086 |
| 1.5 | 5 | 53.5 | 13293 |
| 1.5 | 6 | 52.5 | 8530 |

### Example 9

### 1-MCP Analysis in Various Compositions

For the instant example, the following materials can be utilized: Harvista™ (AF-701), containing 1.21% 1-MCP; 1-MCP/alpha cyclodextrin complex (HAIP), containing 4.68% 1-MCP; 1-MCP/alpha cyclodextrin complex (AFxRD-038), containing 4.05% 1-MCP; and Air milled HAIP, containing 4.29% 1-MCP.

For the instant example, the following procedure was followed:
1. Weighed 3 g air milled HAIP into a ~135 ml Wheaton bottle.
2. Weighed 3 g alpha cyclodextrin into the bottle.
3. Added 54 ml 40 C water into the bottle and then immediately closed the bottle with a vented gas-sampling cap.
4. The bottles were placed on horizontal orbital shaker throughout the experiment, the headspace and liquid phase were analyzed for 1-MCP by GC-FID at various time points.

The following results were obtained for the instant example:

| | | | | |
|---|---|---|---|---|
| Vent hole diameter (mm) | 32 | 8 | 1.19 | 0.26 |
| Time (mins) | 420 | 240 | 240 | 240 |
| 1-MCP concentration in | 4 | 7345 | 8160 | 9485 |
| headspace at 4 hours (ppm v/v) | | | | |
| % 1-MCP retained in liquid | 75 | 90 | 81 | 94 |

### Example 10

### 1-MCP Analysis in Various Compositions

For the instant example, the following materials can be utilized: Harvista™ (AF-701), containing 1.21% 1-MCP; 1-MCP/alpha cyclodextrin complex (HAIP), containing 4.68% 1-MCP; 1-MCP/alpha cyclodextrin complex (AFxRD-038), containing 4.05% 1-MCP; and Air milled HAIP, containing 4.29% 1-MCP.

For the instant example, the following procedure was followed:
1. Prepared an aqueous stock solution saturated with alpha cyclodextrin of either food grade or technical grade at 40 C by adding excessive amount of alpha cyclodextrin till solid sediments were visible.
2. Weighed air milled HAIP into a ~135 ml Wheaton bottle.
3. Added appropriate amount the stock solution at 40 C into the bottle and then immediately sealed the bottle with a gas-sampling cap.
4. The bottles were placed on horizontal orbital shaker throughout the experiment, the headspace was analyzed for 1-MCP by GC-FID at various time points.

The following results were obtained for the instant example:

| | | 40 C. saturated | Average max. 1-MCP |
|---|---|---|---|
| Air | | alpha | concentration |
| milled | Alpha-CD | cyclodextrin | in headspace over |
| HAIP (g) | grade | solution (g) | 4 hours (ppm v/v) |
| 1.5 | food | 58.5 | 6600 |
| 3 | food | 57 | 10350 |
| 6 | food | 54 | 12121 |
| 1.5 | tech | 58.5 | 6254 |
| 3 | tech | 57 | 9854 |
| 6 | tech | 54 | 8386 |

### Example 11

### 1-MCP Analysis in Various Compositions

For the instant example, the following materials can be utilized: Harvista™ (AF-701), containing 1.21% 1-MCP; 1-MCP/alpha cyclodextrin complex (HAIP), containing 4.68% 1-MCP; 1-MCP/alpha cyclodextrin complex (AFxRD-038), containing 4.05% 1-MCP; and Air milled HAIP, containing 4.29% 1-MCP.

For Sample #1, the following procedure was followed:
1. Weighed 2 g air milled HAIP into a ~135 ml Wheaton bottle.
2. Weighed 4 g alpha cyclodextrin into the bottle.
3. Added 54 ml 40 C water into the bottle and then immediately closed the bottle with a gas-sampling cap.
4. The bottles were placed on horizontal orbital shaker throughout the experiment, the headspace was analyzed for 1-MCP by GC-FID at various time points.

For Sample #2, the following procedure was followed:
1. Prepared an aqueous stock solution by mixing 4 g alpha cyclodextrin with 54 ml water.
2. Weighed air milled HAIP into a ~135 ml Wheaton bottle.
3 Warmed the stock solution to 40 C, and added it into the bottle and then immediately sealed the bottle with a gas-sampling cap.
4. The bottles were placed on horizontal orbital shaker throughout the experiment, the headspace was analyzed for 1-MCP by GC-FID at various time points.

The 1-MCP concentration in the headspace after 1 hour was measured to be 8168 ppm v/v for sample #1 and 8080 ppm v/v for sample #2.

### Example 12

### 1-MCP Analysis in Various Compositions

For the instant example, the following materials can be utilized: Harvista™ (AF-701), containing 1.21% 1-MCP; 1-MCP/alpha cyclodextrin complex (HAIP), containing 4.68% 1-MCP; 1-MCP/alpha cyclodextrin complex (AFxRD-038), containing 4.05% 1-MCP; and Air milled HAIP, containing 4.29% 1-MCP.

For the instant example, the following procedure was followed:
1. Weighed air milled HAIP into a ~135 ml Wheaton bottle.
2. Weighed selected cyclodextrins into the bottle.
3. Added 54 ml water equilibrated at selected temperatures into the bottle and then immediately sealed the bottle with a gas-sampling cap.
4. The bottles were placed on horizontal orbital shaker throughout the experiment, the headspace was analyzed for 1-MCP by GC-FID at various time points.

The following results were obtained for the instant example:

| | Beta- | Alpha- | | Water | 1-MCP |
|---|---|---|---|---|---|
| Air | cyclo- | cyclo- | | temper- | concentration |
| milled | dextrin, | dextrin, | Water, | ature, | in headspace at |
| HAIP, g | g | g | ml | C. | 1 hour (ppm v/v) |
| 2 | 4 | 0 | 54 | 40 | 59580 |
| 3 | 3 | 0 | 54 | 40 | 43436 |
| 2 | 0 | Tech grade, 4 | 54 | 40 | 20693 |
| 3 | 0 | Food grade, 6 | 51 | 20 | 1510 |
| 3 | 0 | Food grade, 6 | 51 | 40 | 13669 |
| 2 | 4 | 0 | 54 | 20 | 14528 |
| 2 | 0 | Tech grade, 4 | 54 | 20 | 7382 |
| 2 | 2 | Food grade, 2 | 54 | 20 | 7109 |
| 2 | 0 | Food grade, 4 | 54 | 10 | 3875 |
| 2 | 2 | Food grade, 2 | 54 | 40 | 14372 |
| 2 | 0 | Food grade, 2 | 54 | 40 | 23375 |
| | | Tech grade, 2 | | | |
| 2 | 0 | Food grade, 2 | 54 | 20 | 6352 |
| | | Tech grade, 2 | | | |

### Example 13

### 1-MCP Analysis in Various Compositions

For the instant example, the following materials can be utilized: Harvista™ (AF-701), containing 1.21% 1-MCP; 1-MCP/alpha cyclodextrin complex (HAIP), containing 4.68% 1-MCP; 1-MCP/alpha cyclodextrin complex (AFxRD-038), containing 4.05% 1-MCP; and Air milled HAIP, containing 4.29% 1-MCP.

For the instant example, the following procedure was followed:
1. Prepared 5% by wt aqueous stock solutions of food grade alpha cyclodextrin by mixing 5 weight parts of alpha cyclodextrin with 95 weight parts of water till fully dissolved.
2. Weighed selected 1-MCP products into a ~122 ml serum bottle.
3. Added appropriate amount of 5% stock solution into the bottle and then immediately sealed the bottle with a gas-sampling cap.
4. The bottles were placed on horizontal orbital shaker throughout the experiment, the headspace was analyzed for 1-MCP by GC-FID at various time points.

The following results were obtained for the instant example:

| 1-MCP | AF- | AF- | AFxRD- | Air | |
|---|---|---|---|---|---|
| product | 701 | 701 | 038 | milled | HAIP |
| 1-MCP product | 19.02 | 38.02 | 2.896 | 2.852 | 2.353 |
| weight, g | | | | | |
| 5% α-CD stock | 78.89 | 59.78 | 19.76 | 19.89 | 20.25 |
| solution, g | | | | | |
| Headspace | 2448 | 1728 | 2731 | 3233 | 2545 |
| (ppm) 1 hr | | | | | |

### Example 14

### 1-MCP Analysis in Various Compositions

For the instant example, the following materials can be utilized: Harvista™ (AF-701), containing 1.21% 1-MCP; 1-MCP/alpha cyclodextrin complex (HAIP), containing 4.68% 1-MCP; 1-MCP/alpha cyclodextrin complex (AFxRD-038), containing 4.05% 1-MCP; and Air milled HAIP, containing 4.29% 1-MCP.

For the instant example, the following procedure was followed:
1. Prepared solid blend compositions by mixing appropriate amounts of each solid ingredients thoroughly.
2. Weighed ~6 g of the solid blend composition into a ~135 ml Wheaton bottle.
3. Added 60 ml water into the bottle and then immediately closed the bottle with a gas-sampling cap.

The bottles were placed on horizontal orbital shaker throughout the experiment, the headspace was analyzed for 1-MCP by GC-FID at various time points.

The following results were obtained for the instant example:

| | 25 g air | 18.6 g air | |
|---|---|---|---|
| | milled | milled | 25 g AFxRD- |
| | HAIP | HAIP | 038 |
| | 25 g α-CD | 37.0 g α-CD | 25g α-CD |
| Solid blend | 0.5 g Na4 | 2.2 g Na4 EDTA | 0.5 g Na4 |
| composition | EDTA | 0.53 g silica | EDTA |
| Solid blend | 6.043 | 6.170 | 6.125 |
| weight, g | | | |
| 1-MCP | 10633 | 6417 | 8110 |
| concentration in | | | |
| headspace at 1 | | | |
| hour, ppm v/v | | | |

### Example 15

### Analysis of 1-MCP Containing Aqueous Composition Stability Using Gas-confining Agents

The instant example evaluated the stability of various 1-methylcyclopropene (1-MCP) containing aqueous compositions with and without the presence of a gas-confining agent. Analysis of 1-MCP generated in the headspace was conducted and mathematical subtraction to calculate remainder in solution. A cap of 10000 ppm for 1-MCP in the headspace was utilized given its explosivity limits (e.g., 13000 to 103000 ppm).

The method of 1-MCP analysis is based on comparison of the headspace concentration to the external cis-2-butene standard (9878 ppm created by dilution of 99.30% cis-2-butene.) Materials used for the instant example are as follows:

| Apparatus | Description | Supplier/Model |
|---|---|---|
| Capillary gas | Split/Splitless inlet; FID/MSD | Agilent, Model |
| chromatograph | | 7890/7010 |
| Electronic data system | Open Lab/MassHunter Software | Agilent |
| Capillary columns | PoraBond Q: 25 m × | Agilent |
| | 0.25 mm × 3 μm | |
| Gas tight syringe | 0.25 mL with valve | VICI, side port |
| for GC injections | | needle |
| Barometer/thermometer | Lab monitoring system | Oceaview |
| Analytical balance | Sensitivity +/− 0.01 mg | AND, BM-252 |
| Boston round sample bottle | 252 mL (8 oz) nominal volume, | Berlin Packaging |
| | 24 mm-400 thread mouth | |
| 0.5, 1 L Tedlar ™ bags | Outfitted with septa | Precision Sampling Inc |
| Mechanical Shaker | Reciprocating or orbital | AtLab Shaker Co./Fisher |

Stock of a 1-MCP containing composition (e.g., AF-701) was shaken prior to use in order to ensure homogeneity. The stock was placed on a reciprocating shaker for at least 30 minutes followed by visual inspection to verify that the 1-MCP containing composition is well mixed.

The 1-MCP containing composition (e.g., AF-701) was weighed into a 250 ml Boston round bottle. The specified amount of the gas-confining agent (e.g., 5% α-cyclodextrin) was added and then the resultant aqueous composition was immediately sealed with a gas sample cap. Sample bottles were placed on a horizontal orbital shaker and the headspace of the bottles was analyzed for 1-MCP by GC-FID at various time points.

### Tested Aqueous Composition Samples

| | | | | |
|---|---|---|---|---|
| Gas-confining | 0 | 5 | 0 | 5 |
| Agent (%) | | | | |
| Spray vol. | 200 | 200 | 800 | 800 |
| (L/ha) | | | | |
| Solution vol. | 95.5 | 95.5 | 99 | 99 |
| (ml) | | | (target 98.875) | (target 98.875) |
| AF-701 (ml) | 4.5 | 4.5 | 1.125 | 1.125 |
| AF-701 (g) | 6.066 | 6.097 | 1.264 | 1.320 |

### 1-MCP Concentration in Headspace of the Aqueous Compositions (Ppm)

| time | 0%, | 5%, | time | 0%, | 5%, |
|---|---|---|---|---|---|
| (hrs) | 200 L/ha | 200 L/ha | (hrs) | 800 L/ha | 800 L/ha |
| 0 | — | 363.253 | 0 | 552.8841 | 174.0051 |
| 1 | 36874.51 | 6324.829 | 4 | 28224.41 | 8183.584 |
| 4 | 51392.57 | 6639.227 | 8 | 33053 | 7269.504 |
| 8 | 58688.61 | 7345.682 | 24 | 32813.6 | 4565.34 |
| 24 | 54259.51 | 6144.17 | 32 | 27480.98 | 4534.743 |
| 32 | 52036.03 | 8015.07 | | | |

### % 1-MCP Remaining in Solution for the Aqueous Compositions

| time | 0%, | 5%, | time | 0%, | 5%, |
|---|---|---|---|---|---|
| (hrs) | 200 L/ha | 200 L/ha | (hrs) | 800 L/ha | 800 L/ha |
| 0 | — | 99.82211 | 0 | 98.69398 | 99.6064 |
| 1 | 81.84953 | 96.9026 | 4 | 33.32825 | 81.48884 |
| 4 | 74.7034 | 96.74864 | 8 | 21.92214 | 83.55647 |
| 8 | 71.11213 | 96.40267 | 24 | 25.41525 | 90.06329 |
| 24 | 74.30097 | 97.10472 | 32 | 37.53621 | 90.12989 |
| 32 | 75.35408 | 96.22311 | | | |

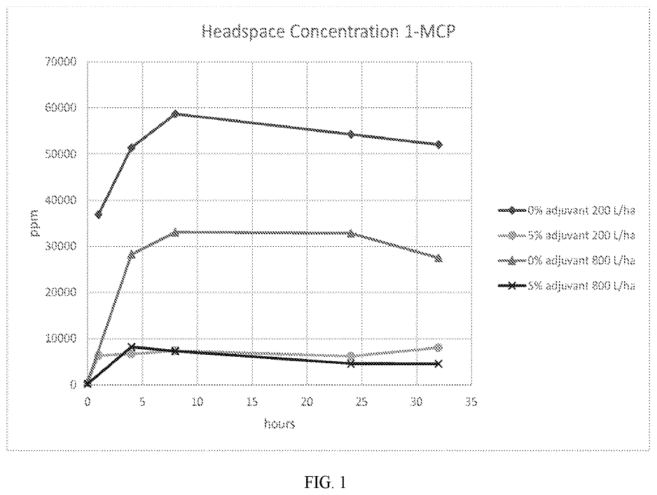

Inclusion of a gas-confining agent demonstrated improved safety for the aqueous 1-MCP containing compositions. As shown in FIG. 1, the amount of 1-MCP in the headspace quickly increases into the explosivity range if a gas-confining agent is not utilized.

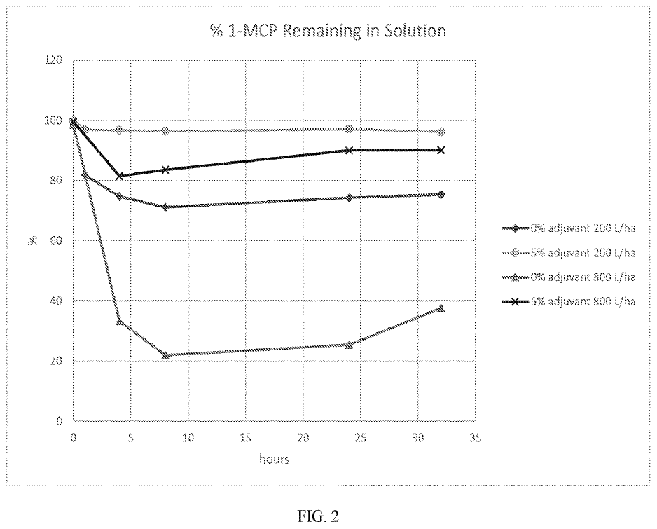

FIG. 2 shows that without inclusion of a gas-confining agent, the amount of 1-MCP needed for effective treatment (e.g., 80% remaining in solution) is not present in the aqueous composition. In other words, inclusion of a gas-confining agent provides a sufficient amount of 1-MCP for effective treatment.

### Example 16

### Further Analysis of 1-MCP Containing Aqueous Composition Stability Using Gas-Confining Agents

The instant example further evaluated the stability of various 1-MCP containing aqueous compositions comprising a gas-confining agent. In particular, the stability was determined at elevated temperatures. Analysis of 1-MCP generated in the headspace was conducted and mathematical subtraction to calculate remainder in solution. A cap of 10000 ppm for 1-MCP in the headspace was utilized given its explosivity limits (e.g., 13000 to 103000 ppm).

The method of 1-MCP analysis is based on comparison of the headspace concentration to the external cis-2-butene standard (9878 ppm created by dilution of 99.30% cis-2-butene.) Materials used for the instant example are as follows:

| Apparatus | Description | Supplier/Model |
|---|---|---|
| Capillary gas | Split/Splitless inlet; FID/MSD | Agilent, Model |
| chromatograph | | 7890/7010 |
| Electronic data system | Open Lab/MassHunter Software | Agilent |
| Capillary columns | PoraBond Q: 25 m × | Agilent |
| | 0.25 mm × 3 μm | |
| Gas tight syringe | 0.25 mL with valve | VICI, side port |
| for GC injections | | needle |
| Barometer/thermometer | Lab monitoring system | Oceaview |
| Analytical balance | Sensitivity +/− 0.01 mg | AND, BM-252 |
| Boston round sample | 252 mL (8 oz) nominal volume, | Berlin Packaging |
| bottle | 24 mm-400 thread mouth | |
| 0.5, 1 L Tedlar ™ bags | Outfitted with septa | Precision Sampling Inc |
| Mechanical Shaker | Reciprocating or orbital | AtLab Shaker Co./Fisher |
| Low Temperature Incubator | Operating temperature −10 to 60° C. | Fisher 146E |

Stock of a 1-MCP containing composition (e.g., AF-701) was shaken prior to use in order to ensure homogeneity. The stock was placed on a reciprocating shaker for at least 30 minutes followed by visual inspection to verify that the 1-MCP containing composition is well mixed.

The 1-MCP containing composition (e.g., AF-701) was weighed into a 250 ml Boston round bottle. The gas-confining agent (e.g., 5% α-cyclodextrin) was warmed to 45° C. and then added to the -MCP containing composition. The resultant aqueous composition was immediately sealed with a gas sample cap. Sample bottles were placed on a horizontal orbital shaker in an incubator set to 45° C., and the headspace of the bottles was analyzed for 1-MCP by GC-FID at various time points.

### Tested Aqueous Composition Samples

Gas-confining Agent (%)

| | 5 | 5 |
|---|---|---|
| Spray vol. | 200 | 800 |
| (L/ha) | | |
| Solution vol. | 95.5 | 99 (target 98.875) |
| (ml) | | |
| AF-701 (ml) | 4.5 | 1.125 |
| AF-701 (g) | 6.065 | 1.750 |

### 1-MCP Concentration in Headspace of the Aqueous Compositions (Ppm)

| time | 5%, | 5%, |
|---|---|---|
| (hrs) | 200 L/ha | 800 L/ha |
| 1.3 | 20923.72 | 3238.952 |
| 3.5 | 18987.92 | 3675.781 |
| 5.5 | 16564.03 | 3689.310 |

### % 1-MCP Remaining in Solution for the Aqueous Compositions

| | Expected | Identified | |
|---|---|---|---|
| | 1-MCP | 1-MCP | |
| | (mg) | (mg) | % |
| 200 L/ha | 67.93 | 47.80 | 70.37 |
| 800 L/ha | 19.60 | 13.71 | 69.94 |

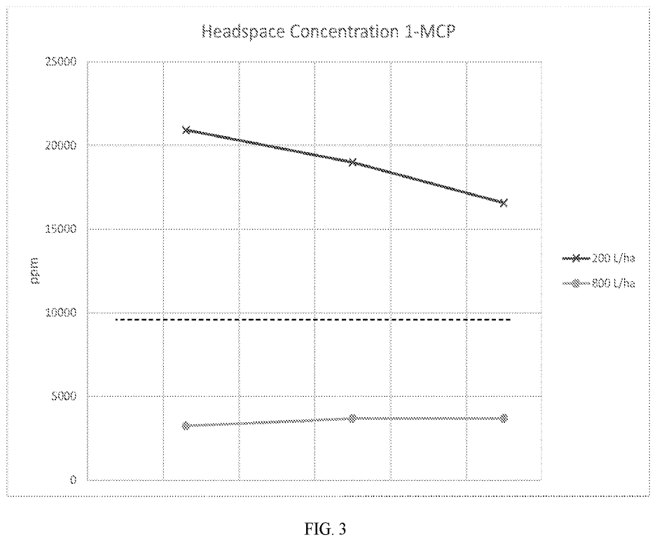

Inclusion of a gas-confining agent demonstrated improved safety for the aqueous 1-MCP containing compositions. As shown in FIG. 3, the amount of 1-MCP in the headspace was maintained below the explosivity range for the aqueous 1-MCP containing composition comprising 800 L/ha. For the more concentrated aqueous 1-MCP containing composition comprising 200 L/ha dilution, the amount of 1-MCP in the headspace was shown to be in the explosivity range. After 5.5 hours, the addition of the gas-confining agent at 5% to the aqueous composition maintains 1-MCP in the aqueous composition at about 70% for both dilution compositions.

### Example 17

### Further Analysis of 1-MCP Containing Aqueous Composition Stability Using Gas-Confining Agents

The instant example further evaluated the stability of various 1-MCP containing aqueous compositions comprising a gas-confining agent. In particular, the stability was determined at elevated temperatures of approximately 80° F. Analysis of 1-MCP generated in the headspace was conducted and mathematical subtraction to calculate remainder in solution. A cap of 10000 ppm for 1-MCP in the headspace was utilized given its explosivity limits (e.g., 13000 to 103000 ppm).

The method of 1-MCP analysis is based on comparison of the headspace concentration to the external cis-2-butene standard (9878 ppm created by dilution of 99.30% cis-2-butene.) Materials used for the instant example are as follows:

| Apparatus | Description | Supplier/Model |
|---|---|---|
| Capillary gas | Split/Splitless inlet; | Agilent, Model |
| chromatograph | FID/MSD | 7890/7010 |
| Electronic data system | Open Lab/MassHunter | Agilent |
| | Software | |
| Capillary columns | PoraBond Q: 25 m × | Agilent |
| | 0.25 mm × 3 μm | |
| Gas tight syringe | 0.25 mL with valve | VICI, side port |
| for GC injections | | needle |
| Barometer/ | Lab monitoring system | Oceaview |
| thermometer | | |
| Analytical balance | Sensitivity +/− 0.01 mg | AND, BM-252 |
| Boston round sample | 252 mL (8 oz) nominal volume, | Berlin |
| bottle | 24 mm-400 thread mouth | Packaging |
| 0.5, 1 L Tedlar ™ | Outfitted with septa | Precision |
| bags | | Sampling Inc |
| Mechanical Shaker | Reciprocating or orbital | AtLab Shaker |
| | | Co./Fisher |
| Low Temperature | Operating temperature −10 | Fisher 146E |
| Incubator | to 60° C. | |

Stock of a 1-MCP containing composition (e.g., AF-701) was shaken prior to use in order to ensure homogeneity. The stock was placed on a reciprocating shaker for at least 30 minutes followed by visual inspection to verify that the 1-MCP containing composition is well mixed.

The 1-MCP containing composition (e.g., AF-701) was weighed into a 250 ml Boston round bottle. The gas-confining agent (e.g., 5% α-cyclodextrin) was warmed to 28° C. and then added to the -MCP containing composition. The resultant aqueous composition was immediately sealed with a gas sample cap. Sample bottles were placed on a horizontal orbital shaker in an incubator set to 45° C., and the headspace of the bottles was analyzed for 1-MCP by GC-FID at various time points. The temperature monitoring system recorded the average temperature as 28.36° C. (i.e.

83.05° F., approximating an expected field temperature). Three separate trials were conducted to collect data at different time points.

At each end point, a sample (~3 ml) of each aqueous composition was analyzed by GC/FID for 1-MCP by comparison to a 150 μl internal standard of 99.30% cis-2-butene.

### Tested Aqueous Composition Samples

Gas-confining Agent (%)

| | 5 | 5 |
|---|---|---|
| Spray vol. | 200 | 800 |
| (L/ha) | | |
| Solution vol. | 95.5 | 99 (target 98.875) |
| (ml) | | |
| AF-701 (ml) | 4.5 | 1.125 |
| AF-701 (g) - | 5.957 | 1.780 |
| 4 hrs. | | |
| AF-701 (g) - | 6.0789 | 1.7878 |
| 7.5 hrs. | | |
| AF-701 (g) - | 6.0906 | 1.7885 |
| 16 hrs. | | |

### Recovery of 1-MCP

| | 200 L/ha | | | 800 L/ha | | |
|---|---|---|---|---|---|---|
| | headspace | % by | % | headspace | % by | % |
| hours | (ppm) | diff¹ | release² | (ppm) | diff | release |
| 4 | 8392 | 96.2 | 78.6 | 7855 | 88.1 | 69.3 |
| 7.5 | 7835 | 96.5 | 81.6 | 4848 | 92.7 | 77.3 |
| 16 | 4579 | 98 | 82.8 | 274 | 99.6 | 69.3 |

¹= % 1-MCP found by subtraction of 1-MCP in headspace from initial amount of 1-MCP
²= % 1-MCP found by GC/FID analysis of a sample of the solution

At ~28° C., inclusion of a gas-confining agent demonstrated improved safety for the aqueous 1-MCP containing compositions. The gas-confining agent maintained the headspace below the explosivity range for the aqueous 1-MCP containing composition comprising 200 L/ha as well as the aqueous 1-MCP containing composition comprising 800 L/ha at time points of 4, 7.5, and 16 hours.

The addition of the gas-confining agent at 5% to the aqueous 1-MCP containing compositions was also shown to maintain a significant portion of the 1-MCP in the solution at both dilution rates.

### Example 18

### Apple Tree Administration of Aqueous Compositions

The instant example evaluated the efficacy of various 1-MCP containing aqueous compositions comprising a gas-confining agent. Four (4) different 1-MCP containing aqueous compositions were applied to apple trees in San Clemente, Chile via drones. The test compositions were compared to untreated controls and to typical “kit” applications utilizing Harvista treatment of trees using a soluble composition comprising 1.3% 1-MCP (i.e., without gas-confining agents).

Different volumes of 1-MCP containing aqueous compositions comprising a gas-confining agent were administered via drone (30, 60, 94 and 200 L ha⁻¹), as well as untreated controls and typical “kit” applications utilizing Harvista treatment. Each treatment had 7 rows of trees with 20 trees per row, with 8 buffer trees between each treatment. There were 3 harvests: commercial harvest (H0), 7 days after commercial harvest (H+7), and 14 days after commercial harvest (H+14). Four trees were harvested for each harvest. The following parameters were evaluated: firmness, color, starch test, weight, ethylene and respiration evaluations, acidity and soluble solids, and fruit drop.

Treatment groups included the following:

| | | | Soluble | | | |
|---|---|---|---|---|---|---|
| | | | composition | | | |
| | | | comprising | | | |
| | | | 1-MCP/α- | | | |
| | | | cyclodextrin | | Gas | |
| | | Spray volume | complex | | confining | |
| | | applied via | (1.3% 1- | | agent (α- | |
| Treatment | | drone | MCP) | Water | cyclodextrin) | Total solution |
| Group | Product | L ha⁻¹ | L tank⁻¹ | L tank⁻¹ | kg tank⁻¹ | to be applied |
| Control | — | — | — | — | — | — |
| (“UTC”) | | | | | | |
| 1 | Soluble | 30 | 4.36 | 9.15 | 0.46 | 1.764 |
| (“Drone | composition | | | | | |
| 30”) | comprising 1- | | | | | |
| | MCP/α- | | | | | |
| | cyclodextrin | | | | | |
| | complex | | | | | |
| | (1.3% 1-MCP) | | | | | |
| | plus gas | | | | | |
| | confining | | | | | |
| | agent α- | | | | | |
| | cyclodextrin | | | | | |
| | (90+% | | | | | |
| | technical | | | | | |
| | grade) | | | | | |
| 2 | Soluble | 60 | 2.18 | 11.23 | 0.56 | 3.528 |
| (“Drone | composition | | | | | |
| 60”) | comprising 1- | | | | | |
| | MCP/α- | | | | | |
| | cyclodextrin | | | | | |
| | complex | | | | | |
| | (1.3% 1-MCP) | | | | | |
| | plus gas | | | | | |
| | confining | | | | | |
| | agent α- | | | | | |
| | cyclodextrin | | | | | |
| | (90+% | | | | | |
| | technical | | | | | |
| | grade) | | | | | |
| 3 | Soluble | 94 | 1.39 | 11.98 | 0.6 | 5.5272 |
| (“Drone | composition | | | | | |
| 94”) | comprising 1- | | | | | |
| | MCP/α- | | | | | |
| | cyclodextrin | | | | | |
| | complex | | | | | |
| | (1.3% 1-MCP) | | | | | |
| | plus gas | | | | | |
| | confining | | | | | |
| | agent α- | | | | | |
| | cyclodextrin | | | | | |
| | (90+% | | | | | |
| | technical | | | | | |
| | grade) | | | | | |
| 4 | Soluble | 200 | 0.65 | 12.68 | 0.63 | 11.76 |
| (“Drone | composition | | | | | |
| 200”) | comprising 1- | | | | | |
| | MCP/α- | | | | | |
| | cyclodextrin | | | | | |
| | complex | | | | | |
| | (1.3% 1-MCP) | | | | | |
| | plus gas | | | | | |
| | confining | | | | | |
| | agent α- | | | | | |
| | cyclodextrin | | | | | |
| | (90+% | | | | | |
| | technical | | | | | |
| | grade) | | | | | |
| 5 | Soluble | | | 1000 | | |
| (“Harvista”) | composition | | | | | |
| | comprising 1- | | | | | |
| | MCP/α- | | | | | |
| | cyclodextrin | | | | | |
| | complex | | | | | |
| | (1.3% 1-MCP) | | | | | |

Four trees were utilized for each treatment per harvest. Each tree was the replicate (R1 to R4) an three harvests were made: H0 (commercial harvest), H+7 (7 days after commercial harvest) and H+14 (14 days after commercial harvest). For each harvest, fruit from each tree was segregated to evaluate the distribution of cover color in 4 categories, 25%<, 25-50%, 50-75% and <75%. For each color category, the quantity of fruit obtained was weighed to determine the potential yield with optimal fruit for harvesting.

The assessments were performed on fruit in commercial harvest condition, cover color categories: 50-75% and >75%. Approximately 48 fruits were selected from each color category for each repetition and distributed as follows. For each cover color category, 48 fruits were required for each repetition, distributed in the 4 evaluations. Twelve (12) fruits were evaluated at harvest and 12 fruits for shelf life evaluation. The remaining 24 fruits were stored at 0° C. for 60 days. Twelve (12) fruits were evaluated after refrigerated storage and the remaining 12 fruits underwent for shelf life evaluation after refrigerated storage.

For pressure, color, starch, browning and size evaluations, 40 fruits were analyzed at each evaluation time for each treatment (10 fruits per replicate). For ethylene and respiration evaluations, 8 fruits were analyzed at each evaluation time for each treatment (i.e., 2 fruits per replicate). For soluble solids and acidity, a composite sample from each replicate was be evaluated. Fruit drop: Fruit from 4 branches of 6 trees per treatment was counted. The number of fruits on the ground of the trees to be harvested will also be counted.

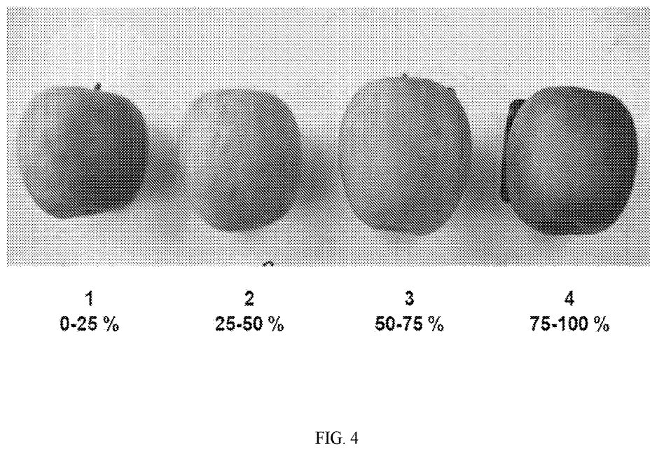

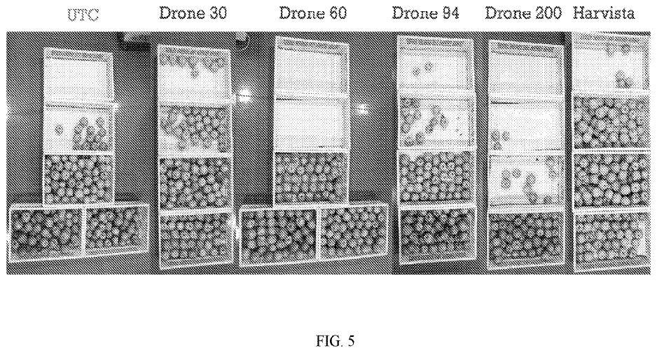

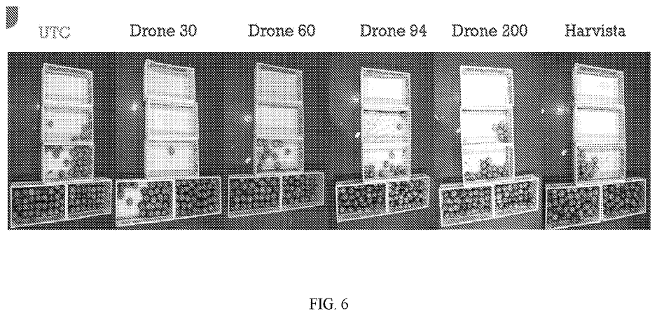

FIG. 4 shows the categories of coverage color analyzed for the fruits of the instant example. FIG. 5 shows the color distribution of fruits at Harvest H0. The following table shows the yield per color category (ton/ha) at Harvest H0, with the mean separation of treatment at each evaluation.

Yield per color category (ton/ha)

| | | | | | Yield per |
|---|---|---|---|---|---|
| | | | | | treatment |
| Treatment | 0-25 | 25-50 | 50-75 | 75-100 | (Ton/ha) |
| UTC | 0.0 | 0.2 | 15.4 | 32.4 | 48.1 a |
| Drone 30 | 0.7 | 2.6 | 13.0 | 43.4 | 59.7 a |
| Drone 60 | 0.1 | 0.4 | 8.7 | 50.2 | 59.4 a |
| Drone 94 | 0.4 | 1.5 | 10.6 | 39.9 | 52.4 a |
| Drone 200 | 0.5 | 0.8 | 10.9 | 47.3 | 59.5 a |
| Harvista | 1.6 | 11.3 | 15.9 | 27.6 | 56.4 a |

The following table shows assessment of quality and conditions of commercial harvest, at the color category 50-75% at different time evaluations from Harvest H0. A comparison of average by columns is shown.

| | | | Assessment of quality conditions | | | | | | | | | |
|---|---|---|---|---|---|---|---|---|---|---|---|---|
| | | | | | | | Acidity | | | | | |
| Days | Days at | | | | Firmness | | (% malic | | TSS | | Weight | |
| 0° C. | 20° C. | Treatments | Starch* | | (lbf) | | acid) | | (°Brix) | | (g) | |
| 0 | 0 | UTC | 6.9 | a | 20.4 | a | 0.58 | ab | 13.7 | b | 164.9 | a |
| | | Drone 30 | 6.3 | ab | 19.5 | ab | 0.60 | ab | 16.8 | a | 173.9 | a |
| | | Drone 60 | 6.2 | b | 19.7 | ab | 0.59 | ab | 14.2 | ab | 170.3 | a |
| | | Drone 94 | 5.2 | c | 19.4 | ab | 0.42 | c | 14.5 | ab | 156.5 | a |
| | | Drone 200 | 5.9 | b | 19.2 | b | 0.50 | bc | 14.0 | b | 175.2 | a |
| | | Harvista 1.3 SC | 5.8 | bc | 19.0 | b | 0.67 | a | 16.3 | ab | 176.2 | a |
| | 14 | UTC | 9.7 | a | 20.0 | a | 0.44 | b | 16.6 | a | 154.1 | ab |
| | | Drone 30 | 9.1 | bc | 18.7 | a | 0.45 | b | 16.5 | a | 161.6 | ab |
| | | Drone 60 | 8.9 | c | 19.3 | a | 0.39 | bc | 16.6 | a | 170.8 | a |
| | | Drone 94 | 8.9 | bc | 19.7 | a | 0.36 | c | 16.3 | a | 141.6 | b |
| | | Drone 200 | 9.5 | ab | 19.6 | a | 0.53 | a | 15.5 | a | 141.1 | b |
| | | Harvista 1.3 SC | 8.7 | c | 19.1 | a | 0.44 | b | 16.6 | a | 169.7 | a |
| 60 | 14 | UTC | 9.2 | b | 15.7 | c | 0.36 | a | 15.0 | a | 237.5 | ab |
| | | Drone 30 | 9.5 | ab | 17.2 | bc | 0.39 | a | 15.4 | a | 242.5 | a |
| | | Drone 60 | 9.6 | ab | 17.9 | ab | 0.36 | a | 15.8 | a | 205.7 | bc |
| | | Drone 94 | 9.7 | a | 18.1 | ab | 0.35 | a | 16.5 | a | 176.7 | c |
| | | Drone 200 | | | | | | | | | | |
| | | Harvista 1.3 SC | 9.2 | b | 19.2 | a | 0.44 | a | 16.5 | a | 221.5 | ab |

The following table shows ethylene production rate and respiration of commercial harvest, color category 50%-75% at different time evaluations from Harvest H0. A comparison of average by columns is shown.

| | | | Ethylene | | Respiration | |
|---|---|---|---|---|---|---|
| | | | production | | rate (mL | |
| Days at | Days at | | rate (uL C₂h₄ | | CO₂ KG⁻¹ | |
| 0° C. | 20° C. | Treatments | Kg⁻¹ Hr⁻¹) | | Hr⁻¹) | |
| 0 | 0 | UTC | 0.33 | a | 13.78 | b |
| | | Drone 30 | 0.18 | a | 12.93 | b |
| | | Drone 60 | 0.14 | a | 13.66 | b |
| | | Drone 94 | 0.09 | a | 11.76 | b |
| | | Drone 200 | 0.42 | a | 22.84 | a |
| | | Harvista 1.3 SC | 0.30 | a | 23.68 | a |
| | 7 | UTC | 0.69 | a | 8.13 | a |
| | | Drone 30 | 0.14 | a | 5.78 | a |
| | | Drone 60 | 0.26 | a | 7.15 | a |
| | | Drone 94 | 0.13 | a | 6.31 | a |
| | | Drone 200 | 0.41 | a | 6.39 | a |
| | | Harvista 1.3 SC | 0.10 | a | 5.52 | a |
| | 14 | UTC | 1.85 | a | 7.20 | abc |
| | | Drone 30 | 0.66 | a | 4.74 | c |
| | | Drone 60 | 0.49 | a | 5.80 | abc |
| | | Drone 94 | 0.19 | a | 5.09 | bc |
| | | Drone 200 | 0.78 | a | 7.58 | ab |
| | | Harvista 1.3 SC | 0.16 | a | 8.12 | a |
| 60 | 0 | UTC | 41.23 | a | 12.26 | ab |
| | | Drone 30 | 20.92 | ab | 10.69 | b |
| | | Drone 60 | 14.28 | ab | 13.16 | ab |
| | | Drone 94 | 33.60 | ab | 14.95 | a |
| | | Drone 200 | | | | |
| | | Harvista 1.3 SC | 9.78 | b | 10.63 | b |
| | 7 | UTC | 38.01 | a | 11.44 | a |
| | | Drone 30 | 6.69 | bc | 9.92 | a |
| | | Drone 60 | 27.25 | ab | 11.62 | a |
| | | Drone 94 | 31.31 | a | 12.55 | a |
| | | Drone 200 | | | | |
| | | Harvista 1.3 SC | 3.13 | c | 8.59 | a |
| | 10 | UTC | 42.81 | a | 10.94 | a |
| | | Drone 30 | 9.66 | bc | 9.17 | a |
| | | Drone 60 | 33.53 | ab | 9.80 | a |
| | | Drone 94 | 34.66 | ab | 10.54 | a |
| | | Drone 200 | | | | |
| | | Harvista 1.3 SC | 3.99 | c | 8.90 | a |
| | 14 | UTC | 36.56 | a | 10.83 | a |
| | | Drone 30 | 15.46 | ab | 8.85 | a |
| | | Drone 60 | 33.88 | ab | 11.75 | a |
| | | Drone 94 | 39.53 | a | 11.08 | a |
| | | Drone 200 | | | | |
| | | Harvista 1.3 SC | 8.55 | b | 10.14 | a |

The following table shows assessment of quality and conditions of commercial harvest, at the color category 75%-100% at different time evaluations from Harvest H0. A comparison of average by columns is shown.

| | | | Assessment of quality conditions | | | | | | | | | |
|---|---|---|---|---|---|---|---|---|---|---|---|---|
| | | | | | | | Acidity | | | | | |
| Days | Days at | | | | Firmness | | (% malic | | TSS | | Weight | |
| 0° C. | 20° C. | Treatments | Starch* | | (lbf) | | acid) | | (°Brix) | | (g) | |
| 0 | 0 | UTC | 5.3 | b | 20.1 | a | 0.6 | a | 14.6 | a | 186.7 | a |
| | | Drone 30 | 6.1 | ab | 19.6 | a | 0.6 | a | 14.1 | a | 175.5 | abc |
| | | Drone 60 | 6.1 | a | 19.7 | a | 0.5 | a | 14.9 | a | 180.0 | ab |
| | | Drone 94 | 5.8 | a | 19.7 | a | 0.6 | a | 15.6 | a | 160.6 | c |
| | | Drone 200 | 4.4 | c | 19.7 | a | 0.6 | a | 14.9 | a | 169.3 | bc |
| | | Harvista 1.3 SC | 5.9 | a | 19.8 | a | 0.5 | a | 15.7 | a | 164.6 | bc |
| | 14 | UTC | 9.5 | a | 19.1 | a | 0.5 | b | 16.4 | a | 180.0 | abc |
| | | Drone 30 | 8.9 | b | 19.5 | a | 0.6 | a | 16.6 | a | 186.3 | a |
| | | Drone 60 | 9.2 | ab | 19.9 | a | 0.5 | ab | 16.4 | a | 182.9 | ab |
| | | Drone 94 | 8.9 | b | 19.5 | a | 0.4 | b | 15.5 | a | 166.9 | bc |
| | | Drone 200 | 9.0 | b | 19.7 | a | 0.4 | b | 16.9 | a | 178.7 | abc |
| | | Harvista 1.3 SC | 9.0 | b | 19.5 | a | 0.5 | ab | 16.9 | a | 166.8 | c |
| 60 | 0 | UTC | 8.5 | a | 18.7 | b | 0.5 | a | 16.6 | a | 224.5 | ab |
| | | Drone 30 | 8.5 | a | 19.3 | ab | 0.5 | a | 16.1 | a | 242.9 | a |
| | | Drone 60 | 8.6 | a | 19.6 | ab | 0.5 | a | 16.4 | a | 226.2 | ab |
| | | Drone 94 | 8.8 | a | 18.9 | ab | 0.4 | a | 15.9 | a | 210.0 | b |
| | | Drone 200 | 8.9 | a | 19.1 | ab | 0.5 | a | 16.5 | a | 218.5 | b |
| | | Harvista 1.3 SC | 8.4 | a | 19.8 | a | 0.5 | a | 17.0 | a | 210.3 | b |
| | 14 | UTC | 9.0 | b | 16.6 | c | 0.5 | a | 16.8 | a | 224.2 | ab |
| | | Drone 30 | 9.5 | a | 18.4 | b | 0.4 | a | 17.0 | a | 237.6 | a |
| | | Drone 60 | 9.8 | a | 18.4 | b | 0.5 | a | 16.6 | a | 230.1 | ab |
| | | Drone 94 | | | | | | | | | | |
| | | Drone 200 | 8.7 | b | 17.7 | b | 0.4 | a | 15.9 | a | 219.2 | ab |
| | | Harvista 1.3 SC | 8.7 | b | 20.1 | a | 0.5 | a | 17.0 | a | 210.7 | b |

The following table shows ethylene production rate and respiration of commercial harvest, color category 75%-100% at different time evaluations from Harvest H0. A comparison of average by columns is shown.

| | | | Ethylene | | Respiration | |
|---|---|---|---|---|---|---|
| | | | production | | rate | |
| Days at | Days at | | rate (uL C₂h₄ | | (mL CO₂ | |
| 0° C. | 20° C. | Treatments | Kg⁻¹ Hr⁻¹) | | KG⁻¹ Hr⁻¹) | |
| 0 | 0 | UTC | 0.36 | a | 13.60 | a |
| | | Drone 30 | 0.27 | ab | 11.51 | ab |
| | | Drone 60 | 0.11 | b | 9.38 | b |
| | | Drone 94 | 0.15 | ab | 11.51 | ab |
| | | Drone 200 | 0.18 | ab | 11.37 | ab |
| | | Harvista 1.3 SC | 0.17 | ab | 12.04 | ab |
| | 7 | UTC | 1.13 | a | 7.02 | ab |
| | | Drone 30 | 0.17 | b | 5.69 | ab |
| | | Drone 60 | 0.13 | b | 6.21 | ab |
| | | Drone 94 | 0.18 | b | 5.06 | b |
| | | Drone 200 | 0.22 | b | 8.47 | a |
| | | Harvista 1.3 SC | 0.12 | b | 6.19 | ab |
| | 14 | UTC | 3.06 | a | 7.59 | a |
| | | Drone 30 | 0.48 | ab | 7.93 | a |
| | | Drone 60 | 0.33 | b | 7.20 | a |
| | | Drone 94 | 0.47 | ab | 9.07 | a |
| | | Drone 200 | 0.45 | ab | 7.44 | a |
| | | Harvista 1.3 SC | 0.36 | b | 7.93 | a |
| 60 | 0 | UTC | 45.49 | a | 16.18 | a |
| | | Drone 30 | 12.93 | b | 12.16 | b |
| | | Drone 60 | 24.19 | b | 13.29 | ab |
| | | Drone 94 | 27.63 | ab | 12.01 | b |
| | | Drone 200 | 26.45 | b | 13.32 | ab |
| | | Harvista 1.3 SC | 11.86 | b | 12.84 | ab |
| | 7 | UTC | 40.06 | a | 12.29 | a |
| | | Drone 30 | 10.76 | bc | 10.09 | a |
| | | Drone 60 | 17.85 | bc | 10.45 | a |
| | | Drone 94 | 20.60 | abc | 9.98 | a |
| | | Drone 200 | 31.59 | ab | 11.12 | a |
| | | Harvista 1.3 SC | 4.61 | c | 9.54 | a |
| | 10 | UTC | 36.94 | a | 10.79 | ab |
| | | Drone 30 | 12.11 | b | 10.50 | ab |
| | | Drone 60 | 18.87 | ab | 9.45 | ab |
| | | Drone 94 | 19.51 | ab | 9.35 | ab |
| | | Drone 200 | 35.60 | a | 9.04 | b |
| | | Harvista 1.3 SC | 9.24 | b | 12.88 | a |
| | 14 | UTC | 38.04 | a | 10.04 | ab |
| | | Drone 30 | 18.79 | a | 9.11 | b |
| | | Drone 60 | 26.81 | a | 9.71 | ab |
| | | Drone 94 | 30.10 | a | 9.68 | ab |
| | | Drone 200 | 37.07 | a | 10.63 | ab |
| | | Harvista 1.3 SC | 17.87 | a | 12.27 | a |

FIG. 6 shows the color distribution of fruits at 7 days after commercial Harvest (H+7). The following table shows the yield per color category (ton/ha) at 7 days after commercial Harvest (H+7), with the mean separation of treatment at each evaluation.

Yield per color category (ton/ha)

| | | | | | Yield per |
|---|---|---|---|---|---|
| | | | | | treatment |
| Treatment | 0-25 | 25-50 | 50-75 | 75-100 | (Ton/ha) |
| UTC | 0.0 | 1.3 | 3.6 | 32.6 | 37.5 a |
| Drone 30 | 0.0 | 0.4 | 3.7 | 51.9 | 55.9 a |
| Drone 60 | 0.0 | 0.0 | 3.2 | 48.8 | 52.0 a |
| Drone 94 | 0.0 | 0.7 | 3.0 | 52.1 | 55.8 a |
| Drone 200 | 0.0 | 2.1 | 8.4 | 55.9 | 66.4 a |
| Harvista | 0.0 | 0.0 | 12.9 | 41.7 | 54.6 a |

The following table shows assessment of quality and conditions of commercial harvest, at the color category 50-75% at different time evaluations at 7 days after commercial Harvest (H+7). A comparison of average by columns is shown.

| | | | Assessment of quality conditions | | | | | | | | | |
|---|---|---|---|---|---|---|---|---|---|---|---|---|
| | | | | | | | Acidity | | | | | |
| Days at | Days at | | | | Firmness | | (% malic | | TSS | | Weight | |
| 0° C. | 20° C. | Treatments | Starch* | | (lbf) | | acid) | | (°Brix) | | (g) | |
| 0 | 0 | UTC | 7.6 | a | 16.2 | a | 0.5 | a | 14.7 | ab | 153.4 | a |
| | | Drone 30 | 7.4 | a | 17.4 | a | 0.6 | a | 15.1 | ab | 164.6 | a |
| | | Drone 60 | 7.8 | a | 17.3 | a | 0.6 | a | 13.7 | b | 170.3 | a |
| | | Drone 94 | 7.9 | a | 17.9 | a | 0.6 | a | 13.8 | b | 156.0 | a |
| | | Drone 200 | 7.7 | a | 16.9 | a | 0.7 | a | 15.9 | a | 175.8 | a |
| | | Harvista 1.3 | 7.9 | a | 16.7 | a | 0.5 | a | 14.4 | ab | 153.6 | a |
| | | SC | | | | | | | | | | |
| | 14 | UTC | 10.0 | a | 18.8 | a | 0.4 | bc | 15.6 | a | 141.2 | c |
| | | Drone 30 | 9.4 | bc | 18.5 | a | 0.4 | ab | 12.8 | b | 176.6 | ab |
| | | Drone 60 | 9.7 | ab | 19.5 | a | 0.4 | c | 14.4 | ab | 158.7 | abc |
| | | Drone 94 | | | | | | | | | | |
| | | Drone 200 | 9.0 | c | 18.7 | a | 0.4 | c | 14.8 | ab | 184.7 | a |
| | | Harvista 1.3 | 9.1 | c | 18.8 | a | 0.5 | a | 15.1 | ab | 155.9 | bc |
| | | SC | | | | | | | | | | |

The following table shows ethylene production rate and respiration of commercial harvest, color category 50%-75% at different time evaluations at 7 days after commercial Harvest (H+7). A comparison of average by columns is shown.

| | | | Ethylene | Respiration | |
|---|---|---|---|---|---|
| | | | production | rate (mL | |
| Days at | Days at | | rate (uL C₂h₄ | CO₂ | |
| 0° C. | 20° C. | Treatments | Kg⁻¹ Hr⁻¹) | KG⁻¹ Hr⁻¹) | |
| 0 | 0 | UTC | 0.38 a | 12.48 | a |
| | | Drone 30 | 0.25 a | 12.41 | a |
| | | Drone 60 | 0.17 a | 11.37 | a |
| | | Drone 94 | 0.15 a | 15.01 | a |
| | | Drone 200 | 0.65 a | 15.43 | a |
| | | Harvista 1.3 SC | 0.09 a | 13.97 | a |
| | 7 | UTC | 4.78 a | 9.30 | a |
| | | Drone 30 | 0.80 a | 9.47 | a |
| | | Drone 60 | 3.13 a | 9.71 | a |
| | | Drone 94 | 1.07 a | 11.33 | a |
| | | Drone 200 | 1.95 a | 9.41 | a |
| | | Harvista 1.3 SC | 0.37 a | 6.62 | a |
| | 14 | UTC | 17.10 a | 10.26 | a |
| | | Drone 30 | 8.68 a | 9.52 | a |
| | | Drone 60 | 15.05 a | 8.76 | a |
| | | Drone 94 | 5.87 a | 11.20 | a |
| | | Drone 200 | 7.51 a | 10.43 | a |
| | | Harvista 1.3 SC | 2.33 a | 9.07 | a |

The following table shows assessment of quality and conditions of commercial harvest, at the color category 75%-100% at different time evaluations at 7 days after commercial Harvest (H+7). A comparison of average by columns is shown.

| | | | Assessment of quality conditions | | | | | | | | | |
|---|---|---|---|---|---|---|---|---|---|---|---|---|
| | | | | | | | Acidity | | | | | |
| Days at | Days at | | | | Firmness | | (% malic | | TSS | | Weight | |
| 0° C. | 20° C. | Treatments | Starch* | | (lbf) | | acid) | | (°Brix) | | (g) | |
| 0 | 0 | UTC | 7.7 | ab | 19.4 | a | 0.5 | a | 15.3 | a | 186.3 | a |
| | | Drone 30 | 7.2 | abc | 19.6 | a | 0.6 | a | 15.2 | a | 186.1 | a |
| | | Drone 60 | 7.0 | c | 19.7 | a | 0.6 | a | 13.5 | b | 183.9 | a |
| | | Drone 94 | 7.3 | bc | 19.3 | a | 0.7 | a | 15.7 | a | 176.3 | a |
| | | Drone 200 | 7.7 | a | 18.6 | a | 0.5 | a | 15.9 | a | 185.5 | a |
| | | Harvista 1.3 | 6.7 | c | 18.6 | a | 0.6 | a | 15.6 | a | 172.4 | a |
| | | SC | | | | | | | | | | |
| | 14 | UTC | 9.0 | a | 18.6 | a | 0.5 | a | 16.4 | a | 192.2 | a |
| | | Drone 30 | 9.3 | b | 19.0 | a | 0.5 | a | 16.6 | a | 185.2 | a |
| | | Drone 60 | 9.2 | a | 19.6 | a | 0.5 | a | 15.7 | a | 171.6 | a |
| | | Drone 94 | 9.2 | ab | 19.3 | a | 0.5 | a | 16.2 | a | 173.8 | a |
| | | Drone 200 | 9.2 | ab | 18.5 | a | 0.5 | a | 15.7 | a | 173.9 | a |
| | | Harvista 1.3 | 9.5 | ab | 18.4 | a | 0.5 | a | 16.5 | a | 186.4 | a |
| | | SC | | | | | | | | | | |
| 60 | 0 | UTC | 8.3 | bc | 18.7 | a | 0.5 | a | 16.5 | a | 221.7 | a |
| | | Drone 30 | 8.5 | bc | 18.7 | a | 0.5 | a | 16.5 | a | 248.0 | a |
| | | Drone 60 | 8.9 | a | 19.3 | a | 0.5 | a | 16.7 | a | 251.2 | a |
| | | Drone 94 | 8.0 | c | 19.5 | a | 0.5 | a | 16.4 | a | 228.0 | a |
| | | Drone 200 | 8.6 | ab | 18.5 | a | 0.5 | a | 16.4 | a | 223.3 | a |
| | | Harvista 1.3 | 8.3 | bc | 19.6 | a | 0.6 | a | 16.3 | a | 225.0 | a |
| | | SC | | | | | | | | | | |
| | 14 | UTC | 9.8 | a | 15.9 | a | 0.4 | a | 16.2 | ab | 219.1 | b |
| | | Drone 30 | 9.3 | cd | 16.6 | a | 0.4 | a | 18.0 | a | 242.3 | ab |
| | | Drone 60 | 9.1 | d | 17.3 | a | 0.4 | a | 17.2 | ab | 252.2 | a |
| | | Drone 94 | 9.7 | ab | 18.2 | a | 0.4 | a | 17.4 | ab | 221.9 | b |
| | | Drone 200 | 9.5 | bc | 17.5 | a | 0.4 | a | 16.1 | b | 219.3 | b |
| | | Harvista 1.3 | 9.5 | bc | 18.5 | a | 0.4 | a | 15.7 | b | 227.0 | ab |
| | | SC | | | | | | | | | | |

The following table shows ethylene production rate and respiration of commercial harvest, color category 75%-100% at different time evaluations at 7 days after commercial Harvest (H+7). A comparison of average by columns is shown.

| | | | Ethylene | | Respiration | |
|---|---|---|---|---|---|---|
| | | | production | | rate (mL | |
| Days at | Days at | | rate (uL C₂h₄ | | CO₂ KG⁻¹ | |
| 0° C. | 20° C. | Treatments | Kg⁻¹ Hr⁻¹) | | Hr⁻¹) | |
| 0 | 0 | UTC | 0.23 | ab | 9.08 | bc |
| | | Drone 30 | 0.13 | b | 8.82 | bc |
| | | Drone 60 | 0.31 | a | 11.32 | ab |
| | | Drone 94 | 0.15 | b | 12.02 | a |
| | | Drone 200 | 0.17 | ab | 8.58 | c |
| | | Harvista 1.3 SC | 0.08 | b | 7.71 | c |
| | 7 | UTC | 5.63 | a | 11.37 | a |
| | | Drone 30 | 1.79 | a | 9.58 | a |
| | | Drone 60 | 2.10 | a | 9.56 | a |
| | | Drone 94 | 1.63 | a | 11.12 | a |
| | | Drone 200 | 2.46 | a | 10.38 | a |
| | | Harvista 1.3 SC | 1.68 | a | 7.91 | a |
| | 14 | UTC | 19.08 | a | 11.71 | a |
| | | Drone 30 | 7.01 | bc | 10.04 | ab |
| | | Drone 60 | 11.91 | ab | 10.50 | ab |
| | | Drone 94 | 4.99 | bc | 10.63 | a |
| | | Drone 200 | 11.12 | abc | 10.62 | a |
| | | Harvista 1.3 SC | 0.55 | c | 7.37 | b |
| 60 | 0 | UTC | 56.32 | a | 19.62 | a |
| | | Drone 30 | 29.16 | bc | 14.30 | b |
| | | Drone 60 | 40.98 | abc | 13.88 | b |
| | | Drone 94 | 36.89 | abc | 16.70 | ab |
| | | Drone 200 | 48.26 | ab | 15.68 | ab |
| | | Harvista 1.3 SC | 17.57 | c | 14.95 | ab |
| | 7 | UTC | 59.40 | a | 13.00 | a |
| | | Drone 30 | 28.62 | b | 12.84 | a |
| | | Drone 60 | 40.51 | ab | 12.17 | a |
| | | Drone 94 | 23.42 | b | 11.13 | a |
| | | Drone 200 | 33.54 | ab | 10.76 | a |
| | | Harvista 1.3 SC | 16.90 | b | 8.88 | a |
| | 11 | UTC | 31.05 | a | 12.60 | a |
| | | Drone 30 | 21.94 | ab | 10.08 | ab |
| | | Drone 60 | 25.79 | ab | 9.90 | ab |
| | | Drone 94 | 20.07 | ab | 8.69 | b |
| | | Drone 200 | 19.03 | ab | 10.67 | ab |
| | | Harvista 1.3 SC | 16.46 | b | 9.97 | ab |
| | 14 | UTC | 30.60 | a | 12.72 | a |
| | | Drone 30 | 21.24 | ab | 10.88 | a |
| | | Drone 60 | 24.65 | ab | 10.68 | a |
| | | Drone 94 | 21.05 | ab | 10.08 | a |
| | | Drone 200 | 24.79 | ab | 11.58 | a |
| | | Harvista 1.3 SC | 17.73 | b | 12.12 | a |

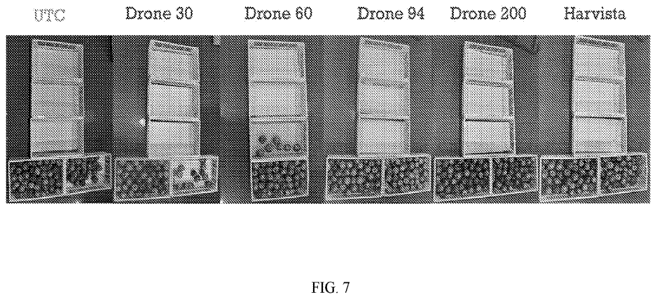

FIG. 7 shows the color distribution of fruits at 14 days after commercial Harvest (H+14). The following table shows the yield per color category (ton/ha) at 14 days after commercial Harvest (H+14), with the mean separation of treatment at each evaluation.

Yield per color category (ton/ha)

| | | | | | Yield per |
|---|---|---|---|---|---|
| | | | | | treatment |
| Treatment | 0-25 | 25-50 | 50-75 | 75-100 | (Ton/ha) |
| UTC | 0.0 | 0.0 | 0.0 | 68.1 | 68.1 a |
| Drone 30 | 0.0 | 0.0 | 0.6 | 53.3 | 53.9 a |
| Drone 60 | 0.0 | 0.0 | 3.7 | 42.1 | 45.8 a |
| Drone 94 | 0.0 | 0.0 | 0.0 | 71.1 | 71.1 a |
| Drone 200 | 0.0 | 0.0 | 0.0 | 64.7 | 64.7 a |
| Harvista | 0.0 | 0.0 | 12.9 | 41.7 | 54.6 a |

The following table shows assessment of quality and conditions of commercial harvest, at the color category 75%-100% at different time evaluations at 14 days after commercial Harvest (H+14). A comparison of average by columns is shown.

| | | | Assessment of quality conditions | | | | | | | | | |
|---|---|---|---|---|---|---|---|---|---|---|---|---|
| | | | | | | | Acidity | | | | | |
| Days at | Days at | | | | Firmness | | (% malic | | TSS | | Weight | |
| 0° C. | 20° C. | Treatments | Starch* | | (lbf) | | acid) | | (°Brix) | | (g) | |
| 0 | 0 | UTC | 8.4 | a | 19.6 | a | 0.7 | a | 16.4 | ab | 184.6 | a |
| | | Drone 30 | 7.8 | bc | 19.1 | a | 0.7 | a | 17.9 | | 182.4 | a |
| | | Drone 60 | 8.2 | ab | 19.4 | a | 0.6 | bc | 17.1 | ab | 179.0 | a |
| | | Drone 94 | 7.9 | bc | 19.2 | a | 0.5 | c | 16.1 | b | 176.0 | a |
| | | Drone 200 | 8.0 | ab | 19.0 | a | 0.7 | a | 17.7 | a | 175.8 | a |
| | | Harvista 1.3 | 7.5 | c | 19.7 | a | 0.7 | ab | 17.7 | a | 174.2 | a |
| | | SC | | | | | | | | | | |
| | 14 | UTC | 9.1 | b | 16.9 | b | 0.5 | b | 15.9 | b | 184.7 | ab |
| | | Drone 30 | 8.9 | b | 18.3 | ab | 0.5 | ab | 16.7 | ab | 193.9 | a |
| | | Drone 60 | 9.6 | a | 17.7 | ab | 0.5 | ab | 16.5 | ab | 188.1 | a |
| | | Drone 94 | 8.4 | c | 17.2 | b | 0.5 | ab | 17.0 | ab | 179.2 | ab |
| | | Drone 200 | 9.7 | a | 18.2 | ab | 0.5 | ab | 16.1 | ab | 163.8 | b |
| | | Harvista 1.3 | 9.2 | b | 19.4 | a | 0.6 | a | 17.6 | a | 178.7 | ab |
| | | SC | | | | | | | | | | |
| 60 | 0 | UTC | 9.7 | a | 17.2 | ab | 0.4 | a | 16.1 | ab | 181.9 | a |
| | | Drone 30 | 9.2 | bc | 17.0 | b | 0.5 | a | 15.8 | ab | 175.5 | a |
| | | Drone 60 | 9.6 | ab | 18.7 | a | 0.5 | a | 15.7 | b | 184.3 | a |
| | | Drone 94 | 8.9 | c | 17.9 | ab | 0.5 | a | 16.2 | ab | 182.7 | a |
| | | Drone 200 | 8.9 | c | 18.7 | a | 0.5 | a | 16.6 | ab | 167.6 | a |
| | | Harvista 1.3 | 9.2 | bc | 18.7 | a | 0.5 | a | 17.4 | a | 179.3 | a |
| | | SC | | | | | | | | | | |
| | 14 | UTC | 8.8 | b | 15.1 | b | 0.4 | a | 16.0 | a | 175.7 | a |
| | | Drone 30 | 9.6 | a | 16.6 | ab | 0.4 | a | 15.8 | a | 178.1 | a |
| | | Drone 60 | 8.4 | c | 16.1 | ab | 0.4 | a | 16.1 | a | 180.0 | a |
| | | Drone 94 | 9.2 | b | 15.7 | b | 0.3 | a | 16.4 | a | 168.6 | a |
| | | Drone 200 | 8.2 | c | 16.3 | ab | 0.3 | a | 16.7 | a | 169.5 | a |
| | | Harvista 1.3 | 8.3 | c | 17.5 | a | 0.3 | a | 16.5 | a | 176.9 | a |
| | | SC | | | | | | | | | | |

The following table shows ethylene production rate and respiration of commercial harvest, color category 75%-100% at different time evaluations at 14 days after commercial Harvest (H+14). A comparison of average by columns is shown.

| | | | Ethylene | | Respiration | |
|---|---|---|---|---|---|---|
| | | | production | | rate (mL | |
| Days at | Days at | | rate (uL C₂h₄ | | CO₂ KG−1 | |
| 0° C. | 20° C. | Treatments | Kg⁻¹ Hr⁻¹) | | Hr⁻¹) | |
| 0 | 0 | UTC | 0.87 | a | 12.01 | a |
| | | Drone 30 | 0.30 | a | 11.48 | a |
| | | Drone 60 | 0.48 | a | 11.25 | a |
| | | Drone 94 | 0.89 | a | 11.73 | a |
| | | Drone 200 | 0.31 | a | 11.03 | a |
| | | Harvista 1.3 SC | 0.49 | a | 10.37 | a |
| | 7 | UTC | 41.29 | a | 15.96 | a |
| | | Drone 30 | 9.46 | bc | 11.84 | cd |
| | | Drone 60 | 22.74 | b | 14.69 | ab |
| | | Drone 94 | 8.12 | c | 12.59 | bc |
| | | Drone 200 | 7.94 | c | 12.07 | bcd |
| | | Harvista 1.3 SC | 1.76 | c | 9.54 | d |
| | 14 | UTC | 39.35 | a | 14.89 | a |
| | | Drone 30 | 15.24 | bc | 11.29 | b |
| | | Drone 60 | 15.91 | bc | 11.04 | b |
| | | Drone 94 | 27.04 | ab | 11.12 | b |
| | | Drone 200 | 11.75 | c | 11.01 | b |
| | | Harvista 1.3 SC | 4.66 | c | 9.19 | b |
| 60 | 0 | UTC | 50.31 | a | 17.14 | a |
| | | Drone 30 | 21.86 | b | 12.57 | b |
| | | Drone 60 | 28.86 | b | 13.71 | ab |
| | | Drone 94 | 33.25 | ab | 13.03 | ab |
| | | Drone 200 | 31.10 | b | 13.48 | ab |
| | | Harvista 1.3 SC | 15.16 | b | 14.38 | ab |
| | 7 | UTC | 43.08 | a | 12.36 | a |
| | | Drone 30 | 19.97 | b | 10.41 | a |
| | | Drone 60 | 20.09 | b | 11.18 | a |
| | | Drone 94 | 20.74 | b | 9.74 | a |
| | | Drone 200 | 23.56 | b | 10.45 | a |
| | | Harvista 1.3 SC | 12.68 | b | 11.93 | a |
| | 10 | UTC | 41.27 | a | 11.58 | ab |
| | | Drone 30 | 23.49 | bc | 12.65 | a |
| | | Drone 60 | 27.10 | b | 9.08 | bc |
| | | Drone 94 | 28.48 | b | 11.47 | ab |
| | | Drone 200 | 25.65 | bc | 11.18 | abc |
| | | Harvista 1.3 SC | 13.95 | c | 8.08 | c |
| | 14 | UTC | 38.11 | a | 12.82 | a |
| | | Drone 30 | 28.61 | ab | 12.09 | a |
| | | Drone 60 | 27.66 | ab | 12.42 | a |
| | | Drone 94 | 29.23 | ab | 13.45 | a |
| | | Drone 200 | 26.14 | ab | 11.21 | a |
| | | Harvista 1.3 SC | 16.61 | b | 11.91 | a |

### Example 19

### Additional Apple Tree Administration of Aqueous Compositions

The instant example can evaluate the efficacy of various 1-MCP containing aqueous compositions comprising a gas-confining agent. In particular, the instant example can provide an efficacy evaluation of aqueous compositions comprising 1-MCP combined with α-cyclodextrin as a gas-confining agent as a pre-mix composition that is applied pre-harvest to apple trees in order to evaluate fruit ripening, fruit drop, and fruit quality.

Various treatment groups can be evaluated, including

| | | | Dosage | Dosage |
|---|---|---|---|---|
| | | | (active | (active |
| Treatment | Active | Other | ingredient), | ingredient) |
| Group | Ingredient | Ingredients | mg/m² | gai/ha |
| 1 | 1.8% 1-MCP | α-cyclodextrin, | 417 | 75 |
| (Treatment | wettable | EDTA | | |
| 1) | powder | | | |
| 2 | 1.8% 1-MCP, | α-cyclodextrin, | 834 | 150 |
| (Treatment | wettable | EDTA | | |
| 2) | powder | | | |
| 3 | 1.8% 1-MCP, | α-cyclodextrin, | 1251 | 225 |
| (Treatment | wettable | EDTA | | |
| 3) | powder | | | |
| 4 | 1.8% 1-MCP, | α-cyclodextrin, | 1668 | 300 |
| (Treatment | wettable | EDTA | | |
| 4) | powder | | | |
| 5 | 20% | | 8000 | — |
| (NAA) | Naphthylacetic | | | |
| | Acid Powder | | | |
| | (NAA; | | | |
| | control) | | | |
| 6 | Blank | | — | 0 |
| (Control) | | | | |

For Treatment Groups 1-4, the 1.8% 1-MCP wettable powder was present in the pre-mix composition at between 35-35% (w/w). Further, α-cyclodextrin was present in the pre-mix composition at between 55-65% (w/w) and EDTA was present at 1% (w/w).

Application of the treatment groups can be administered via a backpack nebulizer or via drone application. Depending on the treatment, the correct amount of water was measured gently added into the nebulizer to dilute the pre-mix composition prior to administration. Actual water usage can be as follows:

| | | | Each treatment | |
|---|---|---|---|---|
| | | | (105 m²) water | |
| | | Dosage | usage ml | Each treatment |
| | | (active | (maximum | (actual area |
| | Dosage, | ingredient) | dilution ratio is | 120 m²) water |
| Treatment | mg/m² | gai/ha | 12 times) | ml |
| 1 | 417 | 75 | 500 | 550 |
| 2 | 834 | 150 | 1000 | 1100 |
| 3 | 1251 | 225 | 1000 | 1100 |
| 4 | 1668 | 300 | 1000 | 1100 |

Analyses can be made as follows. After each harvest, sampled fruits can be divided into two groups. One group can be used for the fruit attribute analysis on the day of the harvest. The other group can be kept under room temperature (22-22° C.) for 14 days for evaluating the change of fruit attributes during the room temperature storage (on-shelf).

For each evaluation, 25 fruits can be sampled for each repeat of each treatment. Before harvest, phytotoxicity, plant growing situation, leaf and fruit residue can be investigated. At harvest, fruit drop rate can be analyzed by counting the number of dropped fruit from each plot and calculating the fruit drop rate (%). After harvest and at on-shelf storage, measurements can include fruit firmness, total soluble solids, total acid, average fruit weight, and ethylene emission. The starch stain index, skin color, skin ground color, external defects, water core, and bitter pit can also be evaluated. Flavor of the fruit can also be tasted.

For fruit starch stain coloring, 10 fruits can randomly be chosen s from each repeat for the starch stain coloring by using potassium iodide. The starch stain index can be graded with 8 levels.

Measurement of total acid in the fruit can be guided by GB/T12456-90. Measurement of fruit firmness can use the GS-15 fruit texture analyzer. For the measurement of each fruit, two spots can be chosen, located along the equator of the fruit, and measured after peeling (unit Kg/cm2)

For the fruit total soluble solid, the PR-101a brix refractometer can be used (unit (%)). For fruit rot, each measurement can count the number of rotted fruit for each treatment group. Fruit skin color can be evaluated and recorded. The fruit skin color can be graded into 5 level: level 0: no red color; level 1: redness area accounted for ≤30%; level 2: redness area 30%~60%; level 3: 60%~90%; level 4: redness area>90%. The skin color index Σ=(number of fruit from each level*number of level)/total fruit number.

Fruit ground color can be evaluated and recorded at each measurement. For instance, 0 means green, 1 means yellow green, 2 means yellow green/yellow, 3 means yellow/brown.

For fruit waster loss (dehydration), the water loss of fruit can be observed and evaluated at each measurement. For instance, 0 means saturated, 1 means slightly dehydrated, 2 means medium dehydrated, 3 means severely dehydrated. The water loss can also be achieved by marking the fruit and then measured the fruit on day one and on the day of the measurement, then water loss (%) can be calculated.

Physiological disorders can be evaluated, as well as flavor tasting. Finally, chemical impact can be evaluated to determine crop safety.

1. An aqueous composition comprising i) 1-MCP, ii) a gas-sequestering agent, and iii) water, wherein the gas-sequestering agent is from about 1% to about 10% by weight of the water in the aqueous composition.

2. The aqueous composition of claim 1, wherein the 1-MCP is comprised in a complex, wherein the complex is an inclusion complex, wherein the inclusion complex comprises alpha-cyclodextrin.

3. (canceled)

4. (canceled)

5. (canceled)

6. (canceled)

7. The aqueous composition of claim 1, wherein the gas-sequestering agent is selected from the group consisting of alpha cyclodextrin, activated charcoal, activated carbon, porous silica, molecular sieve, and any combination thereof.

8. The aqueous composition of claim 1, wherein the gas-sequestering agent comprises alpha cyclodextrin.

9. (canceled)

10. The aqueous composition of claim 1, wherein the gas-sequestering agent is about 5% by weight of the water in the aqueous composition.

11. The aqueous composition of claim 1, wherein the total amount of 1-MCP in the aqueous composition is retained at least 10% by weight of the initial amount of 1-MCP over a period of 24 hours.

12. (canceled)

13. (canceled)

14. (canceled)

15. (canceled)

16. (canceled)

17. (canceled)

18. A method of preparing an aqueous composition comprising the steps of
a) adding water into a vessel,
b) adding a gas-sequestering agent into the vessel,
c) adding 1-MCP into the vessel, and
d) mixing the water, the gas-sequestering agent, and the 1-MCP to form the aqueous composition.

19. (canceled)

20. (canceled)

21. The method of claim 18, wherein the mixing is performed until the aqueous composition is homogenous.

22. The method of claim 18, wherein the 1-MCP is comprised in a complex, wherein the complex is an inclusion complex, wherein the inclusion complex comprises alpha-cyclodextrin, and wherein the complex is present at a concentration from about 0.5% to about 10% by weight of the aqueous composition.

23. (canceled)

24. (canceled)

25. (canceled)

26. The method of claim 18, wherein the gas-sequestering agent comprises alpha cyclodextrin.

27. The method of claim 18, wherein the gas-sequestering agent is from about 1% to about 10% by weight of the water in the aqueous composition.

28. The method of claim 18, wherein the gas-sequestering agent is from about 3% to about 10% by weight of the water in the aqueous composition.

29. The method of claim 18, wherein the gas-sequestering agent is about 5% by weight of the water in the aqueous composition.

30. A method of applying an aqueous composition to a plant or plant part, said method comprising the step of administering the aqueous composition to the plant or plant part via farm equipment, wherein the aqueous composition is the aqueous composition of claim 1.

31. The method of claim 30, wherein the farm equipment comprises ground spray equipment or wherein the farm equipment comprises aerial spray equipment.

32. (canceled)

33. The method of claim 30, wherein the farm equipment comprises drone spray equipment.

34. The method of claim 30, wherein the farm equipment comprises backpack spray equipment.

35. The method of claim 30, wherein the farm equipment comprises a spray tank or vessel.

36. The method of claim 35, wherein the spray tank or vessel is vented.

37. The method of claim 30, wherein the aqueous composition is prepared in-situ.
